(19) United States
(12) Patent Application Publication
(10) Pub. No.: US 2025/0086536 A1
(43) Pub. Date: Mar. 13, 2025

(54) SMART CALL ROUTING USING DEEP LEARNING MODEL

(71) Applicant: Wells Fargo Bank, N.A., San Francisco, CA (US)

(72) Inventors: Abhishek Kumar, Bangalore (IN); Amit Agarwal, Bangalore (IN); Dipanjan Deb, Bangalore (IN); Naveen Gururaja Yeri, Bangalore (IN); Vinothkumar Venkataraman, Bangalore (IN)

(21) Appl. No.: 17/647,971

(22) Filed: Jan. 13, 2022

Related U.S. Application Data
(60) Provisional application No. 63/266,241, filed on Dec. 30, 2021.

(51) Int. Cl. G06Q 10/06; G06N 3/08; G06Q 30/00

(52) U.S. Cl. CPC G06Q 10/063112

(57) ABSTRACT

Techniques are described for routing a customer communication to an agent having appropriate expertise to handle the current communication associated with a customer using one or more machine learning models. For example, a computing system includes a memory and one or more processors in communication with the memory. The one or more processors are configured to: receive a set of emotion factor values for communication data of the current communication; generate, using a composite emotion model running on the one or more processors, a composite emotional score for the current communication based on the set of emotion factor values for the current communication; determine a routing recommendation for the current communication that identifies an agent having appropriate expertise to handle the current communication based on at least the composite emotional score; and route the current communication in accordance with the routing recommendation to a computing device of the agent.

This application claims the benefit of U.S. Provisional Application No. 63/266,241 filed on Dec. 30, 2021, the entire contents of which is incorporated herein by reference.

### TECHNICAL FIELD

The disclosure relates to computing systems, and more specifically, computing systems executing models configured to detect patterns.

### BACKGROUND

A customer service contact center is a facility configured to handle incoming messages from customers or potential customers of a business or organization. One function of the contact center is to route customer communications. Although many customer communications can be handled through online interactions (e.g., via websites, email, or mobile applications), for some businesses a contact center may be regarded as necessary. A contact center may include one or more message analysis systems and one or more agent desktop systems used by a number of human agents that are representatives of the organization.

Sentiment analysis seeks to extract subjective information, such as affective states, from communications. Generally, an algorithm assigns an emotional scale to certain words or phrases in text to classify the polarity of the text as a whole. The polarity is expressed as either positive, negative, or neutral.

### SUMMARY

In general, this disclosure describes techniques for determining the emotive content of customer communications associated with a business or organization using an emotion-based indexer deep learning model and an emotion classifier. More specifically, a computing system may receive data associated with one or more customer communications (e.g., text and annotated data from text-, voice-, and/or video-based customer communications, such as service inquiries). The computing system applies the data for a customer communication as input to the emotion-based indexer deep learning model to determine a set of emotion factor values (e.g., numerical values representing emotion factors) for the customer communication as output. The computing system then applies the emotion factor values for the customer communication, along with historical emotion factor values for previous customer communications as input to a use case specific emotion classifier.

In accordance with the techniques described in this disclosure, the emotion classifier may comprise a composite emotion model configured to determine a composite emotional score of a customer during a communication with the customer. In some examples, the composite emotion model may continually determine a composite emotional score in real-time that reflects changes in the emotions of the customer during a current customer communication. In some examples, the composite emotion model may determine a composite emotional score for historic customer communications. Based at least in part on the composite emotional score, the computing system may route a current communication to an agent having appropriate expertise to effectively serve the current customer given the customer's current emotional disposition and the subject matter of the current communication. In this way, the business or organization may more effectively serve its customers.

In some examples, a computing system includes a memory and one or more processors in communication with the memory. The one or more processors are configured to: receive a set of emotion factor values for communication data of a current communication associated with a customer, wherein each emotion factor value indicates a measure of a particular emotion factor in the current communication; generate, using a composite emotion model running on the one or more processors, a composite emotional score for the current communication based on the set of emotion factor values for the current communication associated with the customer; determine a routing recommendation for the current communication associated with the customer that identifies an agent having appropriate expertise to handle the current communication associated with the customer based on at least the composite emotional score for the current communication; and route the current communication in accordance with the routing recommendation to a computing device of the agent.

In some examples, a method includes: receiving, by one or more processors, a set of emotion factor values for communication data of an current communication associated with a customer, wherein each emotion factor value indicates a measure of a particular emotion factor in the current communication; generating, using a composite emotion model running on the one or more processors, an composite emotional score for the current communication based on the set of emotion factor values for the current communication associated with the customer; determining a routing recommendation for the current communication associated with the customer that identifies an agent having appropriate expertise to handle the current communication associated with the customer based on at least the composite emotional score for the current communication; and routing the current communication in accordance with the routing recommendation to a computing device of the agent.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example operation of an emotion classification engine in accordance with techniques of this disclosure.

FIG. 2 is a block diagram illustrating an example call routing system, in accordance with the techniques of this disclosure.

FIG. 3 is a block diagram illustrating an example computing system for running a DIVA indexer, in accordance with the techniques of this disclosure.

FIG. 4 is a block diagram illustrating an example computing system for running a composite emotion model, in accordance with the techniques of this disclosure.

FIG. 5 is a flow diagram illustrating an example process for determining a routing recommendation for a customer communication, in accordance with the techniques of this disclosure.

FIG. 6 is a flow diagram illustrating an example process for training an emotion-based indexer machine learning model, in accordance with the techniques of this disclosure.

FIG. 7 is a flow diagram illustrating an example process for training a composite emotion model, in accordance with the techniques of this disclosure.

### DETAILED DESCRIPTION

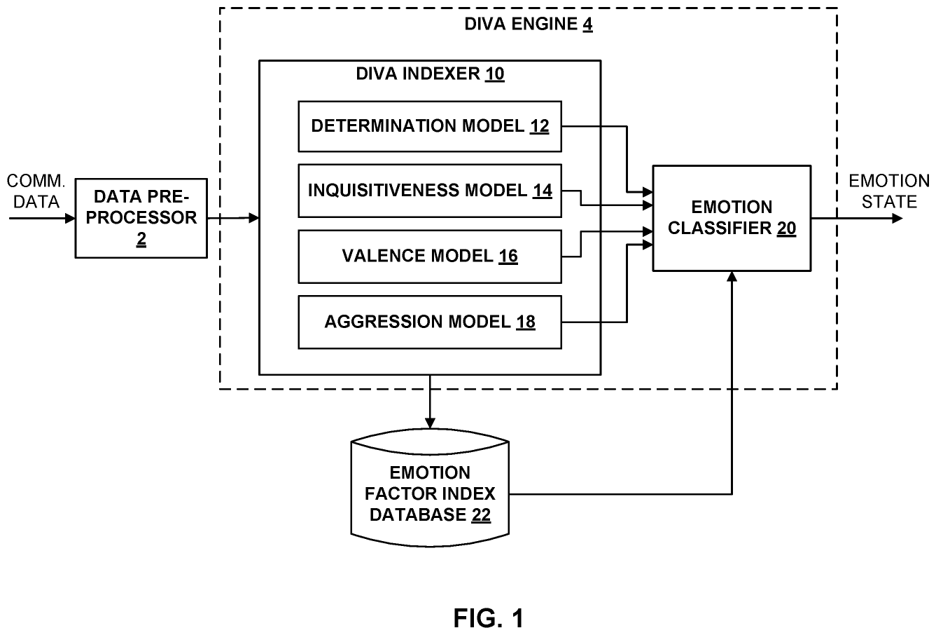

FIG. 1 is a block diagram illustrating an example operation of an emotion classification engine in accordance with techniques of this disclosure.

The emotion classification engine illustrated in FIG. 1 is DIVA engine 4, which refers to the four emotion factor values of Determination, Inquisitiveness, Valence, and Aggression that the engine is configured to determine from input communication data and use to classify the communication data as being associated with a given emotion state. In the illustrated example of FIG. 1, DIVA engine 4 includes a DIVA indexer 10 and an emotion classifier 20. The DIVA indexer 10 may comprise four machine learning models trained to output the four different emotion factor values for communication data. The emotion factor values may be represented as numerical numbers (e.g., between 0 and 1, between −2 and 2, or the like) reflecting the intensity of a specified emotion present in the communication data. For communication data representing a customer communication, for example, a determination model 12 may be trained to output a determination value, an inquisitiveness model 14 may be trained to output an inquisitiveness value, a valence model 16 may be trained to output a valence value, and an aggression model 18 may be trained to output an aggression value. DIVA indexer 10 may output the four emotion factor values to an emotion classifier 20, which may be a machine learning model or a rule-based model, configured to classify the communication data into an associated emotion state (e.g., angry, curious, happy, etc.) based on the four emotion factor values.

DIVA engine 4 may be supported on one or more servers or other computing systems or devices within an organization network. For example, DIVA engine 4 may comprise software code executing on processors or processing circuitry of one or more computing systems that may be included in a centralized or distributed network of disparate computing devices. In some examples, one or more of the emotion factor models 12, 14, 16, and 18 and emotion classifier 20 may each be supported by different computing systems or devices within the network. In other examples, DIVA indexer 10 may be supported on the same computing system, and emotion classifier 20 may be supported on the same computing system or a different computing system within the network.

Upon receipt of communication data representing a customer communication for processing, data pre-processor 2 may perform preprocessing to prepare the communication data for application to the DIVA engine 4 machine learning models. The communication data representing a customer communication may also be saved to a database in memory. The four machine learning models 12, 14, 16, and 18 of the DIVA indexer 10 are trained to recognize certain emotion factors within communication data and output emotion factor values reflecting the presence and intensity of those emotions. The emotion factor values output from DIVA indexer 10 may be saved to an emotion factor index database 22 and an identification number may be assigned to the communication data in memory to associate the communication data with the emotion factor values. The saved emotion factor values may also be associated with a customer who is the source of the communication data. In some examples, the emotion classifier 20 may also retrieve historic, saved emotion factor values for previous communication data associated with the customer from the emotion factor index database 22 as additional input to determine an emotion state of current communication data of the customer. The use of historic emotion factor values of the customer may enable emotion classifier 20 to more accurately classify an emotion state of a customer associated with the current communication data by identifying trends or sudden changes in the emotion factor values of the customer over time. Emotion states may be saved to an emotion state database (not shown in FIG. 1) and associated with the respective communication data, originating customer, and/or emotion factor values.

In some examples, instead of only relying on the specific customer's own historic emotion factor values, emotion classifier 20 may use historic emotion factor values associated with a grouping or profile of customers that includes the specific customer. For example, customer profiles may be identified for groups of customers based on geographical location, education level, age, profession, socioeconomic status, or other categorization. The use of customer profiles may provide a larger historic data set from which emotion classifier 20 may learn to identify emotional trends over time.

Conventional sentiment analysis systems generally classify communication data as being positive, neutral, or negative. Unlike these conventional systems, the emotion classification engine described herein, e.g., DIVA engine 4 of FIG. 1, includes an indexer, e.g., DIVA indexer 10 of FIG. 1, configured to identify the existence and intensity of four emotions specifically useful for financial institutions when handling customer communications. In addition, the machine learning models included within the indexer, e.g., models 12, 14, 16, and 18 of FIG. 1, are trained using communication data received by financial institutions, rather than general communication data from different environments. In this way, the training of the machine learning models within DIVA indexer 10 may be more specific to financial institutions and more accurate in identifying emotive content in communications with a financial institution.

The four emotion factor values output by the machine learning models within DIVA indexer 10 may correspond to a customer's perceived determination, inquisitiveness, valence, and aggression within an inquiry, complaint, or other customer communication. The determination factor value may correspond to a level of purposefulness of the speech of the customer. In some examples, a customer communication that is highly focused on a specific topic may have a high determination factor value. In some examples, a customer communication that repeats itself may have a high determination factor value. In some examples, a customer communication that makes only a short, single statement or a broad, indefinite statement may have a low determination factor value.

The inquisitiveness value may be a measure of the level of curiosity of the speech of the customer communication. In some examples, a customer communication that is probing for information about various aspects of the customer's account or the organization may have a high inquisitiveness value. In some examples, the customer communication that does not indicate an interest in learning anything may have a low inquisitiveness value. The customer who submits a communication with a low inquisitiveness value may wish to resolve any issues without receiving further information.

The valence value may be a measure of the attitude conveyed by the speech of the customer. In some examples, a customer communication that is very negative may have a low valence value. In some examples, a customer communication that is cheerful may have a high valence value. The aggression value may be a measure of the aggressiveness of the speech of the customer communication. In some examples, a customer communication that is brusque may have a high aggression value. In some examples, a customer communication that uses an authoritative tone of voice may have a high aggression value. In some examples, a customer communication that sounds meek or pathetic may have a low aggression value.

An emotion classifier, e.g., emotion classifier 20 of FIG. 1, within the emotion classification engine described herein is configured to classify an emotional state of the customer communication based at least in part on the four emotion factor values output from the machine learning models within DIVA indexer 10 for the customer communication. In some examples, emotion classifier 20 may comprise a machine learning-based or rule-based algorithmic model configured to map the emotion factor values for the customer communication to an emotional state, emotion score, or other emotional indicator. In one example, emotion classifier 20 may have access to a library of emotional states algorithmically tied to different combinations of emotion factor value inputs. The emotional state library may contain emotion states such as “curious,” “trusting,” “disgruntled,” “interesting” etc. As described in this disclosure, the emotion classifier included within the emotion classification engine described herein may be use case specific. In accordance with the techniques described in this disclosure, the emotion classifier may comprise a composite emotion model configured to determine a composite emotional score for a customer communication based on the emotion factor values.

DIVA indexer 10 and emotion classifier 20 may include functions (e.g., machine learning algorithms and/or rule-based algorithms) configured to be executed by processors. In some examples, the machine learning models within DIVA indexer 10 implement supervised learning, e.g., classify sets of data into groups. For example, a set of data, such as a sequence of code pairs representing customer communication data, may be classified into four values (determination, inquisitiveness, valence, and aggression). The function may include nodes, layers, and connections, and the function may be represented by equations having a plurality of variables and a plurality of known coefficients.

Machine learning algorithms, such as those of DIVA engine 4, may be trained using a training process to create data-specific models. After the training process, the created models may be capable of determining an output data set based on an input data set (e.g., match a sequence of text data strings representing a customer communication to one or more known emotion factor values or emotion states). The training process may implement one or more sets of training data to create the models.

A computing system may be configured to train the deep learning models of the DIVA indexer (determination model 12, inquisitiveness model 14, valence model 16, and aggression model 18) based on a set of training data that includes a plurality of customer communications in one or more memories or storage systems within the organization network, in which each customer communication of the plurality of customer communications is pre-categorized as associated with at least one emotion factor value. The deep learning models may include an artificial neural network, such as an RNN. During training of the model, an RNN may identify a plurality of patterns in a plurality of sequences of events. For example, the RNN may observe word phrases of customer communications known to be indicative of an aggressive emotion. After the model is trained, the model may accept a customer communication as an input and output an emotion factor value (e.g., an integer between −2 and 2, inclusive) as an output, a process known as sequence classification.

A computing system may be configured to train a deep learning model like emotion classifier 20 based on a set of training data that includes a plurality of emotion factor value sets in one or more memories or storage systems within the organization network, in which each set of emotion factor values the plurality of sets of emotion factor values is pre-categorized as associated with at least a certain emotion state. The deep learning model may include an artificial neural network, such as an RNN. During training of the model, an RNN may identify a plurality of patterns in a plurality of sequences of events. For example, the RNN may observe emotion factor value combinations known to be indicative of a depressed emotion. After the model is trained, the model may accept a set of emotion factor values as an input and output an emotion classification (e.g., angry, interested, joyful, trusting, depressed, etc.) as an output, a process known as sequence classification.

The DIVA engine 4 may be implemented on any suitable computing system, such as one or more server computers, workstations, mainframes, appliances, cloud computing systems, and/or other computing systems that may be capable of performing operations and/or functions described in accordance with one or more aspects of the present disclosure. In some examples, the DIVA engine 4 may be implemented on a computing system that represents a cloud computing system, server farm, and/or server cluster (or portion thereof) that provides services to customer devices and other devices or systems, e.g., agent workstations within a financial institution. In other examples, the DIVA engine 4 may represent or be implemented through one or more virtualized compute instances (e.g., virtual machines, containers) of a data center, cloud computing system, server farm, and/or server cluster.

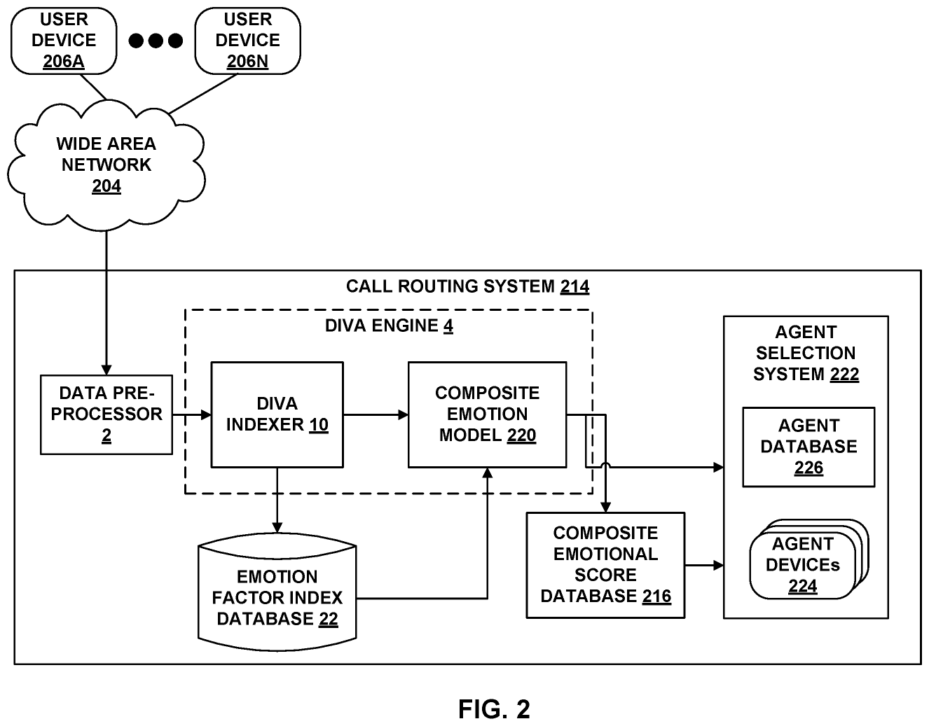

FIG. 2 is a block diagram illustrating an example call routing system 214, in accordance with the techniques of this disclosure. Call routing system 214 includes DIVA engine 4 as described in FIG. 1 in which the emotion classifier is a use case specific composite emotion model 220 configured to determine a composite emotional score for a customer communication based on emotion factor values output by the machine learning models of DIVA indexer 10.

As illustrated in FIG. 2, one or more user devices 206A-206N (collectively “user devices 206”) are in communication with call routing system 214 via a network 204. Call routing system 214 may comprise a network run partially on devices in a facility configured to handle incoming messages from user devices 206 operated by users that may be customers or potential customers of a business or organization. Call routing system 214 may include several disparate computing systems configured to handle customer communications focused on customer accounts with the business or other services provided by the business, e.g., servicing existing accounts, opening new accounts, servicing existing loans, and opening new loans. In some examples described in this disclosure, call routing system 214 may comprise a customer service center of a bank or other financial institution. A contact center of the call routing system 214 may allow customers to speak to a live person when resolving service issues and/or leave a voice message detailing one or more service issues. Additionally, or alternatively, customers may submit messages (e.g., communications, service inquiries, complaints) via text channels such as email, text messaging, and social media messaging.

User devices 206 may be any suitable communication or computing device, such as a conventional or landline phone, or a mobile, non-mobile, wearable, and/or non-wearable computing device capable of communicating over network 204. For example, each user device of user devices 206 may include any one or combination of a landline phone, a conventional mobile phone, a smart phone, a tablet computer, a computerized watch, a computerized glove or gloves, a personal digital assistant, a virtual assistant, a gaming system, a media player, an e-book reader, a television or television platform, a bicycle, automobile, or navigation, information and/or entertainment system for a bicycle, automobile or other vehicle, a laptop or notebook computer, a desktop computer, or any other type of wearable, non-wearable, mobile, and non-mobile computing device that may perform operations in accordance with one or more aspects of the present disclosure. One or more of user devices 206 may support communication services over packet-switched networks, e.g., the public Internet, including Voice over Internet Protocol (VOIP). One or more of user devices 206 may also support communication services over circuit-switched networks, e.g., the public switched telephone network (PSTN).

Call routing system 214 may comprise one or more physical entities (e.g., computing devices, computer servers, quantum computers, desktop computers, tablet computers, laptop computers, smartphones, etc.) and/or virtual entities (e.g., virtual machines, application software in computing machines, a cloud computing system, etc.). In certain examples, call routing system 214 may include one or more computers that process information and/or devices with embedded computers.

Network 204 and call routing system 214 may comprise computer networks (e.g., a wide area network (WAN), such as the Internet, a local area network (LAN), or a virtual private network (VPN)), a telephone network (e.g., the PSTN or a wireless network), or another wired or wireless communication network. Although illustrated as single entities, each of network 204 and call routing system 214 may include a combination of multiple networks. In some examples, network 204 may comprise a public network or a private access network through which user devices 206 may access call routing system 214. In some examples, call routing system 214 may comprise a private network of a business or organization, e.g., a bank or other financial institutions.

Call routing system 214 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, call routing system 214 represents cloud computing systems, server farms, and/or server clusters (or portions thereof) that provide services to customer devices and other devices or systems. In other examples, call routing system 214 may represent or be implemented through one or more virtualized compute instances (e.g., virtual machines, containers) of a data center, cloud computing system, server farm, and/or server cluster. Call routing system 214 may communicate with external systems via one or more networks (e.g., network 204). In some examples, call routing system 214 may use network interfaces (such as Ethernet interfaces, optical transceivers, radio frequency (RF) transceivers, Wi-Fi or Bluetooth radios, or the like), telephony interfaces, or any other type of device that can send and receive information to wirelessly communicate with external systems, e.g., network 204, user device 206, agent devices 224, etc.

Call routing system 214 may include a centralized or distributed network of disparate computing systems made up of interconnected desktop computers, laptops, workstations, wireless devices, network-ready appliances, file servers, print servers, or other computing devices. For example, call routing system 214 may include one or more data centers including a plurality of servers configured to provide account services interconnected with a plurality of databases and other storage facilities in which customer credentials, customer profiles, and customer accounts are stored. Memory of call routing system 214 may be stored on any of the aforementioned devices, and processors of call routing system 214 in communication with the memory may include processors of any of the aforementioned devices.

Call routing system 214 may include systems with which a user may interact, including one or more agent devices 224 used by a number of human agents that are representatives of the business or organization. Call routing system 214 also includes an agent selection system 222. Agent selection system 222 may receive a current composite emotional score for a current communication from composite emotion model 220, and one or more historic composite emotional scores from composite emotional score database 216 to determine a routing recommendation for the current communication associated with the customer that identifies an agent having appropriate expertise to handle the current communication associated with the customer. Agent selection system 222 may also route the current communication in accordance with the routing recommendation to a computing device of the agent (e.g., agent device 224).

In the illustrated example of FIG. 2, call routing system 214 also includes data pre-preprocessor 2, DIVA engine 4 that includes one or more machine learning models within DIVA indexer 10, as described with respect to FIG. 1, and composite emotion model 220. One of user devices 206, e.g., user device 206A, may initiate a communication with call routing system 214 of a financial institution in response to input from a user of user device 206A. User device 206A outputs a signal over wide area network 204. Data pre-processor 2 may prepare communication data received from user device 206 for application to the one or more machine learning models within DIVA engine 4. Call routing system 214 may also include components necessary for collecting, storing, and maintaining data used by call routing system 214. The architecture of call routing system 214 illustrated in FIG. 2 is shown for exemplary purposes only and should not be limited to this architecture. In other examples, call routing system 214 may include more, fewer, or different computing systems configured to handle customer messages/communications.

In some examples, call routing system 214 receives an inbound communication from a user device, e.g., user device 206A, via network 204 and determines whether to route the inbound communication to data pre-processor 2. In accordance with one or more techniques of this disclosure, the communication may comprise communication data in the form of text or audio, such as emails, scanned letters, online chat, telephone calls, etc. A speech recognition model may be used to convert audio communications to plain text data via natural language processing. A text image recognition model may be used to convert hand- or typewritten communications inquiries to plain text data or text-based annotation data.

Text-based annotation data may be a combination of two sets of plain text data. The first set of plain text data may comprise the words and/or text of a customer's message to an organization, while the second set of plain text data may comprise annotations by an agent of the organization. In some examples, the customer may send communication data to an organization in the form of a visual data (e.g., letter, fax, video call, etc.), or audio data (e.g., phone call, web call, video call, etc.). The visual or audio data may have indications of emotive content not captured by the words of the message alone. In that case, an agent of the organization may add annotations, in the form of plain-text data, to the communication data for the customer's message. For example, annotations may describe the customer's behavior during a phone call, including shouting, pleading, and other descriptions of displayed emotion not conveyed through the words of the conversation alone. In some examples, annotations may describe a letter as smudged with tears, or showing circle marks around certain words, and other descriptions of displayed emotion not conveyed through the words in the letter alone. In some examples, image recognition software may add annotations, in the form of plain text data, to the communication data for the customer's message.

Data pre-processor 2 may prepare communication data from a current customer communication for submission to the machine learning models of DIVA engine 4. The machine learning models of DIVA indexer 10 may receive pre-processed communication data as input, and output a set of four emotion factor values indicative of the emotive content of the current communication data. The current emotion factor values may be stored in an emotion factor index database 22 and associated with the current communication data as well as the customer associated with the current communication data. Emotion factor index database 22 may also store one or more historic sets of emotion factor values associated with one or more historic communications, wherein the one or more historic sets of emotion factor values correspond to communication data of one or more historic communications associated with the customer over time, the historic communications occurring prior to the current communication.

One or more processors of call routing system 214 may be configured to receive the set of emotion factor values for communication data of the current communication associated with the customer, wherein each emotion factor value indicates a measure of a particular emotion factor in the current communication. For example, composite emotion model 220 may receive the current set of emotion factor values as input. As described above with reference to FIG. 1, each emotion factor value may indicate a measure of a particular emotion factor in the current communication.

The current communication may be an ongoing communication between the customer and the organization, where the customer has been engaged in conversation with an agent of the organization for a period of time and is currently still engaged in the conversation. For example, the communication may have a duration measured from a beginning of the communication to a current point in the communication. In a first example, call routing system 214 may apply the communication data for an entirety of the duration of the communication to DIVA indexer 10 to determine emotion factor values for the duration of the communication. In some cases, as the communication between the customer and the organization continues, call routing system 214 may periodically apply the communication data for the entirety of the duration of the communication to DIVA indexer 10 to determine updated emotion factor values for the duration of the communication. In a second example, call routing system 214 may apply the communication data for each interval over the duration of the communication to DIVA indexer 10 to determine emotion factor values for the interval of the communication. In the case of the second example, as the communication between the customer and the organization continues, call routing system 214 applies the communication data for the most recent interval of the communication to DIVA indexer 10 to determine emotion factor values for that most recent interval.

In the first example presented above, the communication data includes communication data received over an entirety of the duration. For example, a current communication may start at a certain time, have lasted for five minutes so far, and be ongoing. The communication data over the entirety of the duration may include the communication data of the entire five minutes of the communication so far.

In some examples, call routing system 214 may include a buffer to apply communication data received over the entirety of the duration to DIVA indexer 10 in one or more interims. For example, the buffer may store the entirety of the communication data for the current communication as the communication data is received in real time, and intermittently apply the communication data received over the entirety of the duration to DIVA indexer 10. For example, the current call routing system 214 may continually receive communication data for the current communication for an interim of five minutes. After the five minute interim, call routing system 214 may apply the communication data of the entirety of the first five minutes to DIVA indexer 10. Call routing system 214 may continue to receive communication data for the current communication for another five minute interim for an entire duration of ten minutes. After ten minutes, call routing system 214 may apply the communication data of the entirety of the ten minutes to DIVA indexer 10. Call routing system 214 may continue to apply the communication data received over the entirety of the duration to DIVA indexer 10 every interim (e.g., five minutes) until the current communication ends. In some examples, call routing system 214 may apply the communication data received over the entirety of the duration to DIVA indexer 10 after the communication ends, even if the communication ends before the end of another interim.

Call routing system 214 may store the communication data for the entirety of the current communication in memory as associated with the customer and/or other values stored in memory (e.g., a set of emotion factor values for the communication data, an identifier linked to an open matter, a subject matter classification, an identifier indicative of the current communication) before wiping the buffer for the next communication. In some examples, the interim may be any length of time (e.g., two minutes, ten minutes, etc.) In this way, call routing system 214 may continually update the communication data for the entirety of the duration of the current communication, and, by applying the communication data to DIVA indexer 10, call routing system 214 may subsequently continually generate the set of emotion factor values for the entirety of the duration of the current communication. Sets of emotion factor values determined in this way that are not the current set of emotion factor values (e.g., the last set of emotion factor values determined for the current communication) may be referred to as interim sets emotion factor values.

In the second example presented above, the communication data may include communication data received over an interval of the duration. For example, a current communication may start at a certain time, have lasted for ten minutes so far, and be ongoing. The ten minute duration may be separated into a first five minute interval and a second five minute interval. The communication data received over an interval of the duration may include communication data from the second five minute interval. In some examples, the interval may be any time duration (e.g., two minutes, ten minutes).

In some examples, call routing system 214 may include a buffer to apply communication data received over the interval of the duration to DIVA indexer 10. For example, the buffer may store the interval of the communication data for the current communication as the communication data is received in real time, and intermittently apply the communication data received over the interval to DIVA indexer 10. For example, the call routing system 214 may continually receive communication data for the current communication in five minute intervals. After a first interval, call routing system 214 may apply the communication data of the entirety of the first interval to DIVA indexer 10.

Call routing system 214 may store the communication data received over each interval in memory as associated with the customer and/or other values stored in memory (e.g., a set of emotion factor values for the communication data, an identifier linked to an open matter, a subject matter classification, an identifier indicative of the current communication) before wiping the buffer for the next interval. The buffer of call routing system 214 may continue to receive communication data for a second interval (e.g., five minutes), such that the entire duration of the current communication is ten minutes. After the second interval, call routing system 214 may apply the communication data received over the second interval to DIVA indexer 10. Call routing system 214 may continue to apply the communication data received to DIVA indexer 10 in intervals (e.g., every five minutes) until the current communication ends. In some examples, the duration of the current communication after it ends may not be a perfect multiple of the interval, so call routing system 214 may apply the communication data received in a final period of time since the last full interval of the current communication to DIVA indexer 10 after the communication ends, even if the final period is shorter than the interval. In some examples, the interval may be any length of time (e.g., two minutes, ten minutes, etc.) In this way, call routing system 214 may continually update the communication data for the entirety of the duration of the current communication, and, by applying the communication data to DIVA indexer 10, call routing system 214 may subsequently continually generate the set of emotion factor values for each interval of the duration of the current communication. Sets of emotion factor values determined in this way that are not the current set of emotion factor values (e.g., the last set of emotion factor values determined for the current communication) may be referred to as interval sets of emotion factor values. Interval sets of emotion factor values and interim sets of emotion factor values may both be referred to as types of periodic sets of emotion factor values.

The one or more processors of call routing system 214 may further be configured to generate, using composite emotion model 220 running on the one or more processors, a composite emotional score for the current communication based on the set of emotion factor values for the current communication associated with the customer. In some examples, composite emotion model 220 may be a business rule-based model for generating a composite emotional score for the current communication. In some examples, composite emotion model 220 may be a machine learning model.

In some examples, composite emotion model 220 may be a business rule-based model. For example, composite emotion model 220 may compare each of the current set of emotion factor values to one or more thresholds for the emotion factor values and generate a composite emotional score based on one or more of the current emotion factor values exceeding or falling below a threshold. For example, composite emotion model 220 may extract one or more of an aggression value or valence value from the set of emotion factor values for the current communication and determine the composite emotional score based on the one or more of the aggression value or the valence value for the customer over time.

In some examples, in response to the aggression value exceeding a first threshold, composite emotion model 220 may generate a first composite emotional score indicative of a slight need to route the current communication to an agent having experience handling slightly aggressive customers. In response to the aggression value exceeding a second threshold, where the second threshold is higher than the first threshold, composite emotion model 220 may generate a second composite emotional score, where the second composite emotional score may be indicative of a need route the current communication to an agent having appropriate expertise to handle very aggressive customers.

In some examples, in response to the valence value falling below a first threshold, composite emotion model 220 may generate a first composite emotional score indicative of a slight need to route the current communication to an agent having experience handling slightly sad customers. In response to the valence value falling below a second threshold, where the second threshold is lower than the first threshold, composite emotion model 220 may generate a second composite emotional score, where the second composite emotional score may be indicative of a need route the current communication to an agent having appropriate expertise to handle very sad customers.

In some examples, in response to multiple of the current emotion factor values either exceeding or falling below a threshold, emotion factor index database emotion factor index database 22 may generate a composite emotional score indicative of the need to route the current communication to an agent having experience handling each trait of the customer. For example, composite emotion model 220 may access a table in memory that tabulates composite emotional scores representing multiple emotions, and composite emotion model 220 may identify a composite emotional score representing multiple emotions based on each of the current emotion factor values that exceeds or falls below a threshold.

In some examples composite emotion model 220 may be a machine learning model. The one or more processors of call routing system 214 may apply the set of emotion factor values for the current communication to composite emotion model 220 as input. Composite emotion model 220 may generate, as output from composite emotion model 220, the composite emotional score for the current communication. In some examples, the composite emotional score may be a number value, for example, a number zero through one hundred inclusive indicative of one or more emotional states of the customer. In some examples, the composite emotional score may be a text string, for example “aggressive,” “dejected” or another descriptor of the customer's emotional state.

In some examples, composite emotion model 220 may determine the composite emotional score for the current communication based on one or more historic sets of emotion factor values stored in a database, wherein the one or more historic sets of emotion factor values correspond to communication data of one or more historic communications associated with the customer over time, the historic communications occurring prior to the current communication. For example, call routing system 214 may apply the set of emotion factor values for the current communication and/or the one or more historic sets of emotion factor values associated with the customer to composite emotion model 220 as input and generate, as output, the composite emotional score for the current communication.

In some examples, composite emotion model 220 may determine the composite emotional score for the current communication based on one or more periodic sets of emotion factor values stored in a database, wherein the one or more periodic sets of emotion factor values correspond to communication data of the current communication associated with the customer over one or more intervals or interims of the duration of the current communication. For example, call routing system 214 may apply the set of emotion factor values for the current communication and/or the one or more periodic sets of emotion factor values associated with the customer to composite emotion model 220 as input and generate, as output, the composite emotional score for the current communication.

In order to train composite emotion model 220 as a machine learning model, the one or more processors of call routing system 214 may create a set of training data that includes a plurality of communications, wherein each communication of the plurality of communications comprises a corresponding set of emotion factor values and a label identifying an associated composite emotional score. In some examples, each communication of the plurality of communications comprises one or more corresponding historic sets of emotion factor values as well. The one or more processors may train composite emotion model 220 based on the set of training data.

Call routing system 214 may store the composite emotional score in a database in memory (e.g., composite emotional score database 216) as associated with the customer and/or other values stored in memory (e.g., the communication data for the current communication, the set of emotion factor values used to generate the composite emotional score, an identifier linked to an open matter, a subject matter classification).

Returning to the first example presented above in which call routing system 214 applies the communication data for an entirety of the duration of the communication to DIVA indexer 10 to determine emotion factor values for the duration of the communication, composite emotion model 220 may generate the composite emotional score for the entirety of the duration of the current communication based on the set of emotion factor values for the entirety of the duration of the current communication. For example, composite emotion model 220 may generate one or more composite emotional scores for the duration of the current communication as the duration changes over one or more interims. Composite emotion model 220 may store each composite emotional score of the one or more composite emotional scores in composite emotional score database 216 as associated with the current communication and/or other values stored in memory (e.g., the customer, the set of emotion factor values used to generate the composite emotional score, an identifier linked to an open matter, a subject matter classification). Composite emotional scores determined in this way that are not the current composite emotional score (e.g., the last composite emotional score determined for the current communication) may be referred to as interim composite emotional scores.

Returning to the second example presented above in which call routing system 214 applies the communication data for each interval over the duration of the communication to DIVA indexer 10 to determine emotion factor values for the interval of the communication, composite emotion model 220 may generate the composite emotional score for the interval of the current communication based on the set of emotion factor values for the interval of the current communication. For example, composite emotion model 220 may generate one or more composite emotional scores over one or more intervals of the duration of the current communication. Composite emotion model 220 may store each composite emotional score of the one or more composite emotional scores in composite emotional score database 216 as associated with the current communication and/or other values stored in memory (e.g., the customer, the set of emotion factor values used to generate the composite emotional score, an identifier linked to an open matter, a subject matter classification). Composite emotional scores determined in this way that are not the current composite emotional score (e.g., the last composite emotional score determined for the current communication) may be referred to as interval composite emotional scores. Interval composite emotional scores and interim composite emotional scores may both be referred to as types of periodic composite emotional scores.

The one or more processors of call routing system 214 may also be configured to determine a routing recommendation for the current communication associated with the customer that identifies an agent having appropriate expertise to handle the current communication associated with the customer based on at least the composite emotional score for the current communication. For example, composite emotion model 220 may transmit the composite emotional score for the current communication to agent selection system 222. Agent selection system 222 may receive the composite emotional score from composite emotion model 220 or may retrieve the composite emotional score from composite emotional score database 216.

In some examples, agent selection system 222 may be a business rule-based model configured to determine a routing recommendation for the current communication based on at least the composite emotional score. For example, agent selection system 222 may receive a composite emotional score indicative of an aggressive customer. Agent selection system 222 may search a database in memory (e.g., agent database 226) for an agent of the organization who has experience dealing with aggressive customers. For example, agent selection system 222 may search for an agent where the agent's file in memory may include an identifier indicating that the agent has participated in conflict resolution courses. In some examples, agent selection system 222 determine how many aggressive customers an agent has handled based on information in the agent's file in memory. If agent selection system 222 determines the agent has successfully handled a threshold number of communications where the customer was aggressive, agent selection system 222 may determine that the agent has appropriate expertise to handle the current communication and determine a routing recommendation with the determined agent as a recommended agent. In some examples, agent selection system 222 determines if an agent is already engaged in a current communication with a customer before determining that agent to be the recommended agent.

In some examples, agent selection system 222 may receive a subject matter classification for the current communication and determine the routing recommendation for the current communication based on at least the subject matter classification for the current communication. For example, agent selection system 222 may receive the composite emotional score for the current communication indicative of an aggressive customer and a subject matter classification indicating that the communication is in relation to a specific loan associated with the customer. Agent selection system 222 may determine a routing recommendation to a recommended agent having experience with aggressive customers and experience with the type of loan associated with the customer. In this way, agent selection system 222 may determine a routing recommendation to an agent with expertise in both the emotional state of the customer as well as the subject matter of the current communication.

In some examples, the one or more processors of call routing system 214 and/or agent selection system 222 may be configured to receive an identifier for the current communication indicative of an open matter in the current communication, wherein the open matter represents an unresolved issue or incomplete service for the customer. The one or more processors of call routing system 214 and/or agent selection system 222 may be configured to determine a duration for which the open matter has remained open and determine the routing recommendation for the current communication based on at least the duration for which the open matter has remained open. In some examples, the customer may transmit an open matter identifier from a customer device when initiating the current communication that is received by call routing system 214 and/or agent selection system 222. For example, the customer may input an open matter identifier on the keypad (e.g., or digital representation thereof) of the customer's phone when calling the organization, wherein the open matter identifier is received by call routing system 214 through wide area network 204. In some examples, a current agent communicating with the customer may input the open matter identifier to call routing system 214 during the current communication using one or more agent devices 224. Call routing system 214 may store the open matter identifier in a database in memory. Agent selection system 222 may retrieve the open matter identifier from a database in memory, or may receive the open matter identifier from call routing system 214. Agent selection system 222 may determine a duration for which the open matter has remained open based on time stamps for historic communications of the customer stored in memory associated with the open matter identifier. Agent selection system 222 may compare the earliest time stamp found to an internal time stamp for one or more devices on which the processors of agent selection system 222 are running to determine the duration. Agent selection system 222 may determine a routing recommendation to more senior agents within the organization for longer determined durations of the open matter. Similarly, agent selection system 222 may determine a number of communications in memory associated with the open matter identifier and determine a routing recommendation to more senior agents for a higher determined number of communications associated with the open matter identifier.

The one or more processors of call routing system 214 may also be configured to route the current communication in accordance with the routing recommendation to a computing device (e.g., agent devices 224) of the agent. For example, agent selection system 222 may determine a current agent who may be currently engaged with the customer in the current communication. Composite emotion model 220 may send the routing recommendation to agent device 224 of the current agent, recommending routing the communication to the recommended agent. The current agent may approve the routing recommendation and call routing system 214 may route the communication to the recommended agent. In some examples, the current agent may be a digital or artificial agent of call routing system 214 configured to receive information and communication data from the customer before routing the customer to a live agent. For example, call routing system call routing system 214 may include an online chatbot configured to prompt the customer for personally identifiable information, or information related to the matter associated with the communication. Call routing system 214 may automatically route the customer to a live agent after a sufficient amount of information has been received, or after prompted to be routed to a live agent by the customer. In some examples, the current agent is a live agent using agent device 224.

In some examples, agent selection system 222 may receive one or more periodic composite emotional scores (as described above) from composite emotional score database 216. The one or more periodic composite emotional scores may be interval composite emotional scores and or interim composite emotional scores that were determined for the current communication prior to the current composite emotional score (e.g., the last composite emotional score determined for the current communication). For example, agent selection system 222 may determine the routing recommendation for the current communication based on the current composite emotional score for the entirety of the duration of the current communication. In some examples, agent selection system 222 may determine the routing recommendation for the current communication based on the current composite emotional score for the interval of the current communication, and also based on the one or more periodic composite emotional scores. For example, agent selection system 222 may determine the routing recommendation for the current communication based on a comparison between the current composite emotional score and the one or more periodic composite emotional scores for the current communication.

Agent selection system 222 may determine a routing recommendation based on a difference between the current composite emotional score for the current communication and the one or more periodic composite emotional scores for the current communication. For example, agent selection system 222 may determine an average composite emotional score for the current communication by calculating an average of the one or more periodic composite emotional scores for the current communication. If the current composite emotional score differs from the average composite emotional score by more than a threshold amount, agent selection system 222 may send an alert and a determined routing recommendation to a current agent suggesting routing the recommendation to a recommended agent. For example, during an ongoing communication, composite emotion model 220 may periodically determine one or more composite emotional scores for the current communication based on periodic communication data for the current communication. The periodic communication data may be based on intervals of the duration of the communication or interim determinations based on the entirety of the communication data received up to the current point in the ongoing communication. Agent selection system 222 may periodically determine one or more routing recommendations for the current communication based on the current composite emotional score for the current communication and one or more of the periodic composite emotional scores for the current communication, where the periodic composite emotional scores were determined prior to the current composite emotional score.

In some examples, call routing system 214 may receive an incoming communication from a customer, where communication data for the incoming communication is not available, and determine an initial routing recommendation. For example, call routing system 214 may receive a call from a customer, and determine an initial routing recommendation based on a detected phone number of the customer. For example, call routing system 214 may detect the phone number being used to contact the organization and look up the phone number in a database in memory to determine a potential customer. Based on the determined customer, call routing system 214 may retrieve the most recent communication data for the most recent communication with the customer from memory and determine an initial routing recommendation as described above based on the most recent communication data. Call routing system 214 may route the incoming communication to an agent identified in the initial routing recommendation.

By taking into account the emotive content of customer communications, call routing system 214 may more effectively serve customers by routing them to agents who have the appropriate expertise to handle the current communication. This may decrease stress and other negative emotions associated with business transacted at the organization, and aid in customer retention.

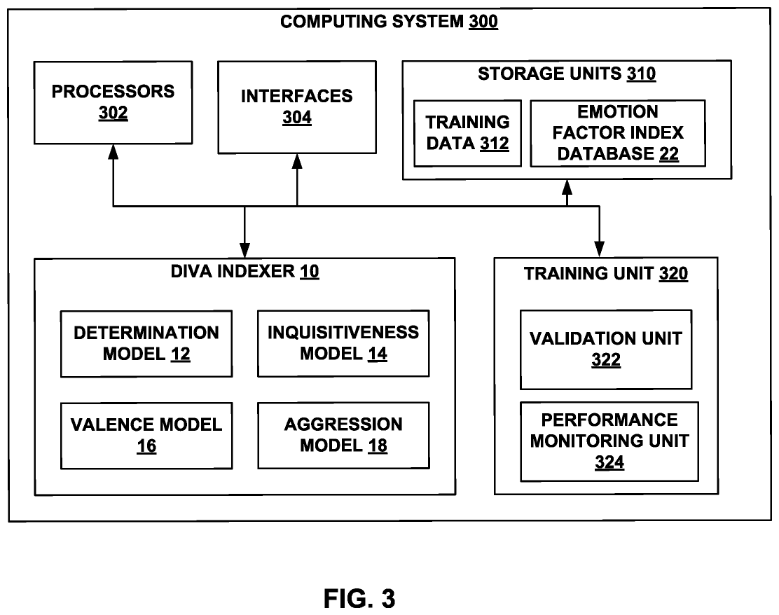

FIG. 3 is a block diagram illustrating an example computing system 300 for running a DIVA indexer, in accordance with the techniques of this disclosure. The architecture of computing system 300 illustrated in FIG. 3 is shown for exemplary purposes only. Computing system 300 should not be limited to the illustrated example architecture. In other examples, computing system 300 may be configured in a variety of ways.

As shown in the example of FIG. 3, a computing system 300 includes one or more processors 302, one or more interfaces 304, and one or more storage units 310. The one or more storage units 310 may house training data 312, and an emotion factor index database 22. The computing system 300 also includes the DIVA indexer 10, and a training unit 320, which may be implemented as program instructions and/or data stored in the storage units 310 and executable by the processors 302. The DIVA indexer 10 may comprise a determination model 12, an inquisitiveness model 14, a valence model 16, and an aggression model 18.

Computing system 300 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 300 represents a cloud computing system, server farm, and/or server cluster (or portion thereof) that provides services to customer devices and other devices or systems. In other examples, computing system 300 may represent or be implemented through one or more virtualized compute instances (e.g., virtual machines, containers) of a data center, cloud computing system, server farm, and/or server cluster.

The storage units 310 of computing system 300 may also store an operating system (not shown) executable by the processors 302 to control the operation of components of the computing system 300. The components, units, or modules of the computing system 300 are coupled (physically, communicatively, and/or operatively) using communication channels for inter-component communications. In some examples, the communication channels may include a system bus, a network connection, an inter-process communication data structure, or any other method for communicating data.

The processors 302, in one example, may comprise one or more processors that are configured to implement functionality and/or process instructions for execution within the computing system 300. For example, processors 302 may be capable of processing instructions stored by storage units 310. Processors 302 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

The computing system 300 may utilize interfaces 304 to communicate with external systems via one or more networks, e.g., a customer service center. Interfaces 304 may be network interfaces (such as Ethernet interfaces, optical transceivers, radio frequency (RF) transceivers, Wi-Fi or Bluetooth radios, or the like), telephony interfaces, or any other type of devices that can send and receive information. In some examples, the computing system 300 utilizes interfaces 304 to wirelessly communicate with external systems, e.g., other computing devices or systems within call routing system 214 of FIG. 2.

Storage units 310 may be configured to store information within the computing system 300 during operation. Storage units 310 may include a computer-readable storage medium or computer-readable storage device. In some examples, storage units 310 include one or more of a short-term memory or a long-term memory. Storage units 310 may include, for example, random access memories (RAM), dynamic random-access memories (DRAM), static random-access memories (SRAM), magnetic discs, optical discs, flash memories, or forms of electrically programmable memories (EPROM) or electrically erasable and programmable memories (EEPROM). In some examples, storage units 310 are used to store program instructions for execution by processors 302. Storage units 310 may be used by software or applications running on the computing system 300 to temporarily store information during program execution.

Computing system 300 includes one or more machine learning models of DIVA indexer 10 and a training unit 320 used to train each of the machine learning models of DIVA indexer 10 using training data 312. As seen in FIG. 3, DIVA indexer 10 includes determination model 12, inquisitiveness model 14, valence model 16, and aggression model 18. The training unit 320 includes validation unit 322 and performance monitoring unit 324.

Machine learning algorithms or functions (e.g., a word embedding algorithm) are trained to create the machine learning models within DIVA indexer 10, configured to accept an input sequence of plain text data or text-based annotation data associated with a message and output, using determination model 12, inquisitiveness model 14, valence model 16, and aggression model 18, four emotion factor values including a determination value, an inquisitiveness value, a valence value, and an aggression value, where each value is an integer between −2 and 2 inclusive (although the integer range could consist of any range useful for the application) representing the intensity of the respective emotion contained within the message. For example, for each emotion factor value, −2 and −1 may be considered low values, while 1 and 2 may be considered high values. For example, a message could be scored with a determination value of negative one, a valence value of zero, an inquisitiveness value of two, and aggression value of two. The machine learning models within DIVA indexer 10 may generate emotion factor values based on text characteristics. For example, aggression model 18 may generate an aggression value of two for an incoming message if a set of text data associated with the incoming message has greater than a threshold level of similarity to known characteristics of messages with aggression values of two, as identified by aggression model 18.

Determination model 12 may be trained to determine a determination value based on input communication data representing a message. A machine learning model may be trained using a training process to create a data-specific model, such as determination model 12, based on training data 312. After the training process, the created model may be capable of determining an output data set based on an input data set (e.g., generate a determination value representing a level of determination emotion in a message based on communication data). The training process may implement a set of training data (e.g., training data 312) to create the model.

Determination model 12 may include functions configured to be executed by processors 302. In some examples, determination model 12 implements supervised learning, e.g., classifies sets of data into groups. For example, a set of data, such as communication data indicative of a message to a financial institution, may be classified with a determination value of negative two, negative one, zero, one, or two. In some examples, the function may include nodes, layers, and connections, and the function may be represented by equations having a plurality of variables and a plurality of known coefficients.

For example, determination model 12 may receive communication data in the form of plain-text or text-based annotation data and may parse the communication data to identify a sequence of items including any one or combination of words, phrases, characters (e.g., punctuation), and numerical values corresponding to a determination emotion and an intensity of the determination emotion. Determination model 12 may output a determination value comprised of an integer between −2 and 2 inclusive, where a higher number represents a higher determination emotion in the message. For example, a determination value of negative two may represent a lowest determination emotion within the message, a determination value of two may represent a highest determination emotion in the message, and a determination value of zero may represent a neutral determination emotion in the message. DIVA indexer 10 may store the determination value in an emotion factor index database 22 and assign an ID to the determination value to associate it with the message and the other emotion factor values generated for the message.

Training data 312 may include data indicative of a plurality of messages. At least some of the plurality of messages may represent customer complaints, responses, transcripts of calls or letters submitted to call routing system 214. The plurality of messages may include a group of messages with a determination value of negative 2, a group of messages with a determination value of negative one, a group of messages with a determination value of zero, a group of messages with a determination value of one, and a group of messages with a determination value of two, where each message of the plurality of messages is known to have a determination value of negative two, negative one, zero, one, or two. In one example, training data 312 contains data representing about equal numbers of messages with determination values of each number negative two through two. In another example, training data 312 contains data including a greater number of messages with a determination value of two than messages with a determination value of zero. In another example, training data 312 contains data including a greater number of messages with a determination value of zero than messages with a determination value of two. Other examples are contemplated wherein training data 312 contains data including a greater number of messages with any particular determination value than a number of messages with any other particular determination value. Training unit 320 may access training data 312 stored in storage units 310, and training unit 320 may train determination model 12 using training data 312.

Validation unit 322 may be configured to determine an accuracy of determination model 12. For example, validation unit 322 may use determination model 12 to determine if an example message corresponding to a known determination value has a determination value of negative two, negative one, zero, one, or two. Validation unit 322 may determine if determination model 12 was able to correctly score the incoming message. Additionally, validation unit 322 may be configured to determine the accuracy of determination model 12 for a plurality of messages example each corresponding to a determination value, and validation unit 322 may be configured to identify an accuracy (e.g., a success rate) in which determination model 12 correctly scores the messages for each determination value. If the accuracy is above a threshold accuracy value, determination model 12 may be used to classify incoming messages to call routing system 214. If the accuracy is below the threshold accuracy value, training unit 320 may re-train determination model 12 based on an updated set of training data. In some examples, the threshold accuracy value in which determination model 12 may be used may be greater than or equal to 90%. In some examples, validation unit 322 may be configured to identify an accuracy in which determination model 12 correctly scores the determination values of a plurality of messages.

Training unit 320 may include performance monitoring unit 324. Performance monitoring unit 324 may monitor a performance of determination model 12 after it is applied to score incoming messages to call routing system 214 (e.g., score the four emotion factor values as integers between −2 and 2 inclusive). In some examples, performance monitoring unit 324 may determine an accuracy of determination model 12 by comparing determination values scored by determination model 12 with known determination values of a plurality of messages. For example, if determination model 12 determines that an incoming message has a determination value of negative two, and the incoming message is discovered to have a determination value of one, performance monitoring unit 324 may record that an incorrect determination value was generated. Performance monitoring unit 324 may continuously monitor an accuracy of determination model 12. Performance monitoring unit 324 may determine a fraction of messages in which determination model 12 correctly scores an incoming message. The fraction may represent a measured accuracy of determination model 12. New messages may be analyzed by performance monitoring unit 324, the new messages representing data that was not used by training unit 320 to create determination model 12. In other words, performance monitoring unit 324 may test the accuracy of determination model 12 continuously using new data. In some examples, if performance monitoring unit 324 determines that the accuracy of determination model 12 is below a threshold accuracy value (e.g., 90%), performance monitoring unit 324 may output an instruction to re-train determination model 12.

Training unit 320 may periodically (e.g., monthly, bi-monthly, yearly, or the like) re-train determination model 12 based on an updated set of training data. The updated set of training data may include part or all of the plurality of messages of training data 312. Additionally, the updated set of training data may include a set of messages that are received by call routing system 214 during a time since determination model 12 was last trained by training unit 320.

Inquisitiveness model 14 may be trained to determine an inquisitiveness value based on input communication data representing a message. A machine learning model may be trained using a training process to create a data-specific model, such as inquisitiveness model 14, based on training data 312. After the training process, the created model may be capable of determining an output data set based on an input data set (e.g., generate an inquisitiveness value representing a level of inquisitive emotion in a message based on communication data). The training process may implement a set of training data (e.g., training data 312) to create the model.

Inquisitiveness model 14 may include functions configured to be executed by processors 302. In some examples, inquisitiveness model 14 implements supervised learning, e.g., classifies sets of data into groups. For example, a set of data, such as communication data indicative of a message to a financial institution, may be classified with an inquisitiveness value of negative two, negative one, zero, one, or two. In some examples, the function may include nodes, layers, and connections, and the function may be represented by equations having a plurality of variables and a plurality of known coefficients.

For example, inquisitiveness model 14 may receive communication data in the form of plain-text or text-based annotation data and may parse the communication data to identify a sequence of items including any one or combination of words, phrases, characters (e.g., punctuation), and numerical values corresponding to an inquisitive emotion and an intensity of the inquisitive emotion. Inquisitiveness model 14 may output an inquisitiveness value comprised of an integer between −2 and 2 inclusive, where a higher number represents a higher inquisitive emotion in the message. For example, an inquisitiveness value of negative two may represent a lowest inquisitive emotion within the message, an inquisitiveness value of two may represent a highest inquisitive emotion in the message, and an inquisitiveness value of zero may represent a neutral inquisitive emotion in the message. DIVA indexer 10 may store the inquisitiveness value in an emotion factor index database 22 and assign an ID to the inquisitiveness value to associate it with the message and the other emotion factor values generated for the message.

Training data 312 may include data indicative of a plurality of messages. At least some of the plurality of messages may represent customer complaints, responses, transcripts of calls or letters submitted to call routing system 214. The plurality of messages may include a group of messages with an inquisitiveness value of negative 2, a group of messages with an inquisitiveness value of negative one, a group of messages with an inquisitiveness value of zero, a group of messages with an inquisitiveness value of one, and a group of messages with an inquisitiveness value of two, where each message of the plurality of messages is known to have an inquisitiveness value of negative two, negative one, zero, one, or two. In one example, training data 312 contains data representing about equal numbers of messages with inquisitiveness values of each number negative two through two. In another example, training data 312 contains data including a greater number of messages with an inquisitiveness value of two than messages with an inquisitiveness value of zero. In another example, training data 312 contains data including a greater number of messages with an inquisitiveness value of zero than messages with an inquisitiveness value of two. Other examples are contemplated wherein training data 312 contains data including a greater number of messages with any particular inquisitiveness value than a number of messages with any other particular inquisitiveness value. Training unit 320 may access training data 312 stored in storage units 310, and training unit 320 may train inquisitiveness model 14 using training data 312.

Validation unit 322 may be configured to determine an accuracy of inquisitiveness model 14. For example, validation unit 322 may use inquisitiveness model 14 to determine if an example message corresponding to a known inquisitiveness value has an inquisitiveness value of negative two, negative one, zero, one, or two. Validation unit 322 may determine if inquisitiveness model 14 was able to correctly score the incoming message. Additionally, validation unit 322 may be configured to determine the accuracy of inquisitiveness model 14 for a plurality of messages example each corresponding to an inquisitiveness value, and validation unit 322 may be configured to identify an accuracy (e.g., a success rate) in which inquisitiveness model 14 correctly scores the messages for each inquisitiveness value. If the accuracy is above a threshold accuracy value, inquisitiveness model 14 may be used to classify incoming messages to call routing system 214. If the accuracy is below the threshold accuracy value, training unit 320 may re-train inquisitiveness model 14 based on an updated set of training data. In some examples, the threshold accuracy value in which inquisitiveness model 14 may be used may be greater than or equal to 90%. In some examples, validation unit 322 may be configured to identify an accuracy in which inquisitiveness model 14 correctly scores the inquisitiveness values of a plurality of messages.

Training unit 320 may include performance monitoring unit 324. Performance monitoring unit 324 may monitor a performance of inquisitiveness model 14 after it is applied to score incoming messages to call routing system 214 (e.g., score the four emotion factor values as integers between −2 and 2 inclusive). In some examples, performance monitoring unit 324 may determine an accuracy of inquisitiveness model 14 by comparing inquisitiveness values scored by inquisitiveness model 14 with known inquisitiveness values of a plurality of messages. For example, if inquisitiveness model 14 determines that an incoming message has an inquisitiveness value of negative two, and the incoming message is discovered to have an inquisitiveness value of one, performance monitoring unit 324 may record that an incorrect inquisitiveness value was generated. Performance monitoring unit 324 may continuously monitor an accuracy of inquisitiveness model 14. Performance monitoring unit 324 may determine a fraction of messages in which inquisitiveness model 14 correctly scores an incoming message. The fraction may represent a measured accuracy of inquisitiveness model 14. New messages may be analyzed by performance monitoring unit 324, the new messages representing data that was not used by training unit 320 to create inquisitiveness model 14. In other words, performance monitoring unit 324 may test the accuracy of inquisitiveness model 14 continuously using new data. In some examples, if performance monitoring unit 324 determines that the accuracy of inquisitiveness model 14 is below a threshold accuracy value (e.g., 90%), performance monitoring unit 324 may output an instruction to re-train inquisitiveness model 14.

Training unit 320 may periodically (e.g., monthly, bi-monthly, yearly, or the like) re-train inquisitiveness model 14 based on an updated set of training data. The updated set of training data may include part or all of the plurality of messages of training data 312. Additionally, the updated set of training data may include a set of messages that are received by call routing system 214 during a time since inquisitiveness model 14 was last trained by training unit 320.

Valence model 16 may be trained to determine a valence value based on input communication data representing a message. A machine learning model may be trained using a training process to create a data-specific model, such as valence model 16, based on training data 312. After the training process, the created model may be capable of determining an output data set based on an input data set (e.g., generate a valence value representing a level of negative or positive emotion in a message based on communication data). The training process may implement a set of training data (e.g., training data 312) to create the model.

Valence model 16 may include functions configured to be executed by processors 302. In some examples, valence model 16 implements supervised learning, e.g., classifies sets of data into groups. For example, a set of data, such as communication data indicative of a message to a financial institution, may be classified with a valence value of negative two, negative one, zero, one, or two. In some examples, the function may include nodes, layers, and connections, and the function may be represented by equations having a plurality of variables and a plurality of known coefficients.

For example, valence model 16 may receive communication data in the form of plain-text or text-based annotation data and may parse the communication data to identify a sequence of items including any one or combination of words, phrases, characters (e.g., punctuation), and numerical values corresponding to a positive or negative emotion and an intensity of the emotion. Valence model 16 may output a valence value comprised of an integer between −2 and 2 inclusive, where a higher number represents a more positive emotion in the message. For example, a valence value of negative two may represent a very negative emotion within the message, a valence value of two may represent a very positive emotion in the message, and a valence value of zero may represent a neutral emotion in the message. DIVA indexer 10 may store the valence value in an emotion factor index database 22 and assign an ID to the valence value to associate it with the message and the other emotion factor values generated for the message.

Training data 312 may include data indicative of a plurality of messages. At least some of the plurality of messages may represent customer complaints, responses, transcripts of calls or letters submitted to call routing system 214. The plurality of messages may include a group of messages with a valence value of negative 2, a group of messages with a valence value of negative one, a group of messages with a valence value of zero, a group of messages with a valence value of one, and a group of messages with a valence value of two, where each message of the plurality of messages is known to have a valence value of negative two, negative one, zero, one, or two. In one example, training data 312 contains data representing about equal numbers of messages with valence values of each number negative two through two. In another example, training data 312 contains data including a greater number of messages with a valence value of two than messages with a valence value of zero. In another example, training data 312 contains data including a greater number of messages with a valence value of zero than messages with a valence value of two. Other examples are contemplated wherein training data 312 contains data including a greater number of messages with any particular valence value than a number of messages with any other particular valence value. Training unit 320 may access training data 312 stored in storage units 310, and training unit 320 may train valence model 16 using training data 312.

Validation unit 322 may be configured to determine an accuracy of valence model 16. For example, validation unit 322 may use valence model 16 to determine if an example message corresponding to a known valence value has a valence value of negative two, negative one, zero, one, or two. Validation unit 322 may determine if valence model 16 was able to correctly score the incoming message. Additionally, validation unit 322 may be configured to determine the accuracy of valence model 16 for a plurality of messages example each corresponding to a valence value, and validation unit 322 may be configured to identify an accuracy (e.g., a success rate) in which valence model 16 correctly scores the messages for each valence value. If the accuracy is above a threshold accuracy value, valence model 16 may be used to classify incoming messages to call routing system 214. If the accuracy is below the threshold accuracy value, training unit 320 may re-train valence model 16 based on an updated set of training data. In some examples, the threshold accuracy value in which valence model 16 may be used may be greater than or equal to 90%. In some examples, validation unit 322 may be configured to identify an accuracy in which valence model 16 correctly scores the valence values of a plurality of messages.

Training unit 320 may include performance monitoring unit 324. Performance monitoring unit 324 may monitor a performance of valence model 16 after it is applied to score incoming messages to call routing system 214 (e.g., score the four emotion factor values as integers between −2 and 2 inclusive). In some examples, performance monitoring unit 324 may determine an accuracy of valence model 16 by comparing valence values scored by valence model 16 with known valence values of a plurality of messages. For example, if valence model 16 determines that an incoming message has a valence value of negative two, and the incoming message is discovered to have a valence value of one, performance monitoring unit 324 may record that an incorrect valence value was generated. Performance monitoring unit 324 may continuously monitor an accuracy of valence model 16. Performance monitoring unit 324 may determine a fraction of messages in which valence model 16 correctly scores an incoming message. The fraction may represent a measured accuracy of valence model 16. New messages may be analyzed by performance monitoring unit 324, the new messages representing data that was not used by training unit 320 to create valence model 16. In other words, performance monitoring unit 324 may test the accuracy of valence model 16 continuously using new data. In some examples, if performance monitoring unit 324 determines that the accuracy of valence model 16 is below a threshold accuracy value (e.g., 90%), performance monitoring unit 324 may output an instruction to re-train valence model 16.

Training unit 320 may periodically (e.g., monthly, bi-monthly, yearly, or the like) re-train valence model 16 based on an updated set of training data. The updated set of training data may include part or all of the plurality of messages of training data 312. Additionally, the updated set of training data may include a set of messages that are received by call routing system 214 during a time since valence model 16 was last trained by training unit 320.

Aggression model 18 may be trained to determine an aggression value based on input communication data representing a message. A machine learning model may be trained using a training process to create a data-specific model, such as aggression model 18, based on training data 312. After the training process, the created model may be capable of determining an output data set based on an input data set (e.g., generate an aggression value representing a level of aggressive emotion in a message based on communication data). The training process may implement a set of training data (e.g., training data 312) to create the model.

Aggression model 18 may include functions configured to be executed by processors 302. In some examples, aggression model 18 implements supervised learning, e.g., classifies sets of data into groups. For example, a set of data, such as communication data indicative of a message to a financial institution, may be classified with an aggression value of negative two, negative one, zero, one, or two. In some examples, the function may include nodes, layers, and connections, and the function may be represented by equations having a plurality of variables and a plurality of known coefficients.

For example, aggression model 18 may receive communication data in the form of plain-text or text-based annotation data and may parse the communication data to identify a sequence of items including any one or combination of words, phrases, characters (e.g., punctuation), and numerical values corresponding to an aggressive emotion and an intensity of the aggressive emotion. Aggression model 18 may output an aggression value comprised of an integer between −2 and 2 inclusive, where a higher number represents a higher aggressive emotion in the message. For example, an aggression value of negative two may represent a lowest aggressive emotion within the message, an aggression value of two may represent a highest aggressive emotion in the message, and an aggression value of zero may represent a neutral aggressive emotion in the message. DIVA indexer 10 may store the aggression value in an emotion factor index database 22 and assign an ID to the aggression value to associate it with the message and the other emotion factor values generated for the message.

Training data 312 may include data indicative of a plurality of messages. At least some of the plurality of messages may represent customer complaints, responses, transcripts of calls or letters submitted to call routing system 214. The plurality of messages may include a group of messages with an aggression value of negative 2, a group of messages with an aggression value of negative one, a group of messages with an aggression value of zero, a group of messages with an aggression value of one, and a group of messages with an aggression value of two, where each message of the plurality of messages is known to have an aggression value of negative two, negative one, zero, one, or two. In one example, training data 312 contains data representing about equal numbers of messages with aggression values of each number negative two through two. In another example, training data 312 contains data including a greater number of messages with an aggression value of two than messages with an aggression value of zero. In another example, training data 312 contains data including a greater number of messages with an aggression value of zero than messages with an aggression value of two. Other examples are contemplated wherein training data 312 contains data including a greater number of messages with any particular aggression value than a number of messages with any other particular aggression value. Training unit 320 may access training data 312 stored in storage units 310, and training unit 320 may train aggression model 18 using training data 312.

Validation unit 322 may be configured to determine an accuracy of aggression model 18. For example, validation unit 322 may use aggression model 18 to determine if an example message corresponding to a known aggression value has an aggression value of negative two, negative one, zero, one, or two. Validation unit 322 may determine if aggression model 18 was able to correctly score the incoming message. Additionally, validation unit 322 may be configured to determine the accuracy of aggression model 18 for a plurality of messages example each corresponding to an aggression value, and validation unit 322 may be configured to identify an accuracy (e.g., a success rate) in which aggression model 18 correctly scores the messages for each aggression value. If the accuracy is above a threshold accuracy value, aggression model 18 may be used to classify incoming messages to call routing system 214. If the accuracy is below the threshold accuracy value, training unit 320 may re-train aggression model 18 based on an updated set of training data. In some examples, the threshold accuracy value in which aggression model 18 may be used may be greater than or equal to 90%. In some examples, validation unit 322 may be configured to identify an accuracy in which aggression model 18 correctly scores the aggression values of a plurality of messages.

Training unit 320 may include performance monitoring unit 324. Performance monitoring unit 324 may monitor a performance of aggression model 18 after it is applied to score incoming messages to call routing system 214 (e.g., score the four emotion factor values as integers between −2 and 2 inclusive). In some examples, performance monitoring unit 324 may determine an accuracy of aggression model 18 by comparing aggression values scored by aggression model 18 with known aggression values of a plurality of messages. For example, if aggression model 18 determines that an incoming message has an aggression value of negative two, and the incoming message is discovered to have an aggression value of one, performance monitoring unit 324 may record that an incorrect aggression value was generated. Performance monitoring unit 324 may continuously monitor an accuracy of aggression model 18. Performance monitoring unit 324 may determine a fraction of messages in which aggression model 18 correctly scores an incoming message. The fraction may represent a measured accuracy of aggression model 18. New messages may be analyzed by performance monitoring unit 324, the new messages representing data that was not used by training unit 320 to create aggression model 18. In other words, performance monitoring unit 324 may test the accuracy of aggression model 18 continuously using new data. In some examples, if performance monitoring unit 324 determines that the accuracy of aggression model 18 is below a threshold accuracy value (e.g., 90%), performance monitoring unit 324 may output an instruction to re-train aggression model 18.

Training unit 320 may periodically (e.g., monthly, bi-monthly, yearly, or the like) re-train aggression model 18 based on an updated set of training data. The updated set of training data may include part or all of the plurality of messages of training data 312. Additionally, the updated set of training data may include a set of messages that are received by call routing system 214 during a time since aggression model 18 was last trained by training unit 320.

Computing system 300 may receive communication data indicative of a customer communication and input the plain text data to DIVA indexer 10. The machine learning models 12, 14, 16, and 18 of DIVA indexer 10 output the four emotion factor values and store the emotion factor values in emotion factor index database 22. Computing system 300 may then send the emotion factor values, e.g., using interfaces 304, to another computing system executing a composite emotion model 220 of FIG. 2 configured to determine a composite emotional priority score for the communication data based on the emotion factor values.

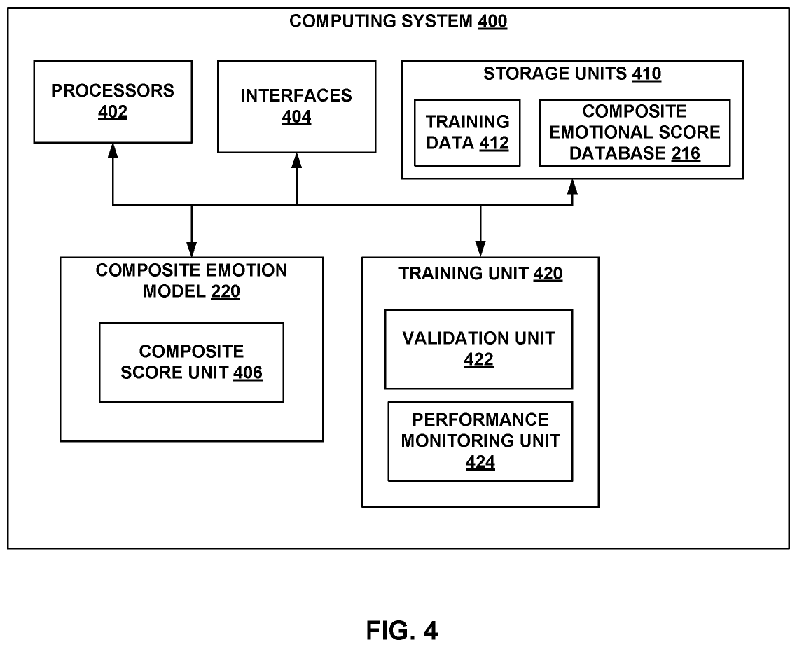

FIG. 4 is a block diagram illustrating an example computing system 400 for running a composite emotion model 220, in accordance with the techniques of this disclosure. The architecture of computing system 400 illustrated in FIG. 4 is shown for exemplary purposes only. Computing system 400 should not be limited to the illustrated example architecture. In other examples, computing system 400 may be configured in a variety of ways. Although computing system 300 and computing system 400 are illustrated herein as separate systems, in other examples DIVA indexer 10 and composite emotion model 220 may be run on a single, shared computing system.

Computing system 400 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 400 represents a cloud computing system, server farm, and/or server cluster (or portion thereof) that provides services to customer devices and other devices or systems. In other examples, computing system 400 may represent or be implemented through one or more virtualized compute instances (e.g., virtual machines, containers) of a data center, cloud computing system, server farm, and/or server cluster.

As shown in the example of FIG. 4, a computing system 400 includes one or more processors 402, one or more interfaces 404, and one or more storage units 410. The one or more storage units 410 may store training data 412, and/or a composite emotional score database 216. The computing system 400 also includes the composite emotion model 220, and a training unit 420, which may be implemented as program instructions and/or data stored in the storage units 410 and executable by the processors 402.

The storage units 410 of the computing system 400 may also store an operating system (not shown) executable by the processors 402 to control the operation of components of the computing system 400. The components, units, or modules of the computing system 400 are coupled (physically, communicatively, and/or operatively) using communication channels for inter-component communications. In some examples, the communication channels may include a system bus, a network connection, an inter-process communication data structure, or any other method for communicating data.

The processors 402, in one example, may comprise one or more processors that are configured to implement functionality and/or process instructions for execution within the computing system 400. For example, processors 402 may be capable of processing instructions stored by storage units 410. Processors 402 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Computing system 400 may utilize interfaces 404 to communicate with external systems via one or more networks, e.g., a customer service center. Interfaces 404 may be network interfaces (such as Ethernet interfaces, optical transceivers, radio frequency (RF) transceivers, Wi-Fi or Bluetooth radios, or the like), telephony interfaces, or any other type of devices that can send and receive information. In some examples, the computing system 400 utilizes interfaces 404 to wirelessly communicate with external systems, e.g., other computing devices or systems within call routing system 214 of FIG. 2.

Storage units 410 may be configured to store information within the computing system 400 during operation. Storage units 410 may include a computer-readable storage medium or computer-readable storage device. In some examples, storage units 410 include one or more of a short-term memory or a long-term memory. Storage units 410 may include, for example, random access memories (RAM), dynamic random-access memories (DRAM), static random access memories (SRAM), magnetic discs, optical discs, flash memories, or forms of electrically programmable memories (EPROM) or electrically erasable and programmable memories (EEPROM). In some examples, storage units 410 are used to store program instructions for execution by processors 402. Storage units 410 may be used by software or applications running on the computing system 400 to temporarily store information during program execution.

Computing system 400 includes a machine learning composite emotion model 220 with a composite score unit 406. Computing system 400 also includes a training unit 420. As seen in FIG. 4, training unit 420 includes validation unit 422 and performance monitoring unit 424.

In some examples, composite emotion model 220 may be configured to determine a composite emotional score based on a set of emotion factor values for the current communication associated with a customer. Computing system 400 may retrieve, e.g., using interfaces 404, the emotion factor values associated with a current communication from emotion factor index database 22. Composite emotion model 220 may receive one or more of the emotion factor values as input and output a composite emotional score. In some examples, the composite emotional score may be a number (e.g., zero or one, between zero and one hundred inclusive), where higher numbers may reflect a heightened emotional state of the customer associated with the current communication. The composite emotional score may be stored in a composite emotional score database 216 and associated with the current communication. In this way, composite emotion model 220 may identify emotive patterns and states representing a heightened or particular emotive response of the customer from the sets of emotion factor values for customer communications.

Composite emotion model 220 may include functions configured to be executed by processors 402. In some examples, composite emotion model 220 implements supervised learning, e.g., classifies sets of data into groups. For example, a set of data, such as a set of one or more emotion factor values indicative of the emotion content in a communication sent to a financial institution, may be classified with a composite emotional score. In some examples, the function may include nodes, layers, and connections, and the function may be represented by equations having a plurality of variables and a plurality of known coefficients.

Machine learning algorithms, such as some examples of composite emotion model 220, may be trained using a training process to create data-specific models, such as composite emotion model 220 based on training data 412. After the training process, the created model may be capable of determining an output data set based on an input data set (e.g., generate a composite emotional score based on a set of one or more emotion factor values). The training process may implement a set of training data (e.g., training data 412) to create the model. Training data 412 may include data indicative of a plurality of sets of emotion factor values. At least some of the plurality of sets of emotion factor values may represent the emotive content of customer communications submitted to computing system 400.

In one example, the plurality of sets of emotion factor values may include a group of sets of emotion factor values labeled with a first composite emotional score, a group of sets of emotion factor values labeled with a second composite emotional score, and so on for each composite emotional score of a plurality of composite emotional scores, where each group of sets of emotion factor values of the plurality of sets of emotion factor values is known to have a particular composite emotional score. In some examples, training data 412 contains data representing about equal numbers of sets of emotion factor values labeled with each composite emotional score of the plurality of composite emotional scores. In another example, training data 412 contains data including a greater number of sets of emotion factor values labeled with a first composite emotional score than a number of sets of emotion factor values labeled with a second composite emotional score. Other examples are contemplated wherein training data 412 contains data including a greater number of sets of emotion factor values labeled with any particular composite emotional score than a number of sets of emotion factor values labeled with any other particular composite emotional score.

In some examples, a machine learning algorithm or function (e.g., a word embedding algorithm) is trained to create composite emotion model 220 configured to accept an input set of emotion factor values associated with a current customer communication for a particular customer, and output, using composite score unit 406, a composite emotional score for the customer. For example, composite emotion model 220 may output classifications based on mapped patterns of emotion factor values. For example, composite emotion model 220 may generate a composite emotional score of seven if the input set of emotion factor values associated with the current communication and the baseline set of emotion factor values have a greater than threshold level of similarity to known characteristics of sets of emotion factor values with a composite emotional score of seven, as identified by composite score unit 406 with reference to composite emotional score database 216. Training unit 420 may output composite emotional scores to storage units 410.

Validation unit 422 may be configured to determine an accuracy of composite emotion model 220. In some examples, validation unit 422 may use composite emotion model 220 to determine if example sets of emotion factor values for customer communications correspond to a known composite emotional score. Validation unit 422 may determine if composite emotion model 220 is able to correctly generate the composite emotional scores based on the set of emotion factor values. Additionally, validation unit 422 may be configured to determine the accuracy of composite emotion model 220 for a plurality of example composite emotional scores, each corresponding to one or more sets of emotion factor values associated with customer communications, and validation unit 422 may be configured to identify an accuracy (e.g., a success rate) in which composite emotion model 220 correctly scores the one or more sets of emotion factor values. If the accuracy is above a threshold accuracy value, composite emotion model 220 may be used to generate composite emotional scores based at least in part on sets of emotion factor values output by DIVA indexer 10. If the accuracy is below the threshold accuracy value, training unit 420 may re-train composite emotion model 220 based on an updated set of training data. In some examples, the threshold accuracy value in which composite emotion model 220 may be used may be greater than or equal to 90%. In some examples, validation unit 422 may be configured to identify an accuracy in which composite emotion model 220 correctly scores a plurality of sets of emotion factor values and baseline sets of emotion factor values.

Training unit 420 may include performance monitoring unit 424. Performance monitoring unit 424 may monitor a performance of composite emotion model 220 after it is applied to generate composite emotional scores based on sets of emotion factor values.

In some examples, performance monitoring unit 424 may determine an accuracy of composite emotion model 220 by comparing composite emotional scores generated by composite emotion model 220 with known composite emotional scores of a plurality of sets of emotion factor values. For example, if composite emotion model 220 scores an incoming set of emotion factor values with a composite emotional score of eight, and the set of emotion factor values is discovered to have a composite emotional score of five, performance monitoring unit 424 may record that an incorrect composite emotional score was generated. Performance monitoring unit 424 may continuously monitor an accuracy of composite emotion model 220. Performance monitoring unit 424 may determine a fraction of sets of emotion factor values in which composite emotion model 220 correctly scores a communication with a composite emotional score. The fraction may represent a measured accuracy of the model. New sets of emotion factor values and baseline sets of emotion factor values may be analyzed by performance monitoring unit 424, the new sets of emotion factor values and baseline sets of emotion factor values representing data that was not used by training unit 420 to create the model. In other words, performance monitoring unit 424 may test the accuracy of the model continuously using new data. In some examples, if performance monitoring unit 424 determines that the accuracy of composite emotion model 220 is below a threshold accuracy value (e.g., 90%), performance monitoring unit 424 may output an instruction to re-train composite emotion model 220.

Training unit 420 may periodically (e.g., monthly, bi-monthly, yearly, or the like) re-train composite emotion model 220 based on an updated set of training data. The updated set of training data may include part or all of the plurality of sets of emotion factor values of training data 412. Additionally, the updated set of training data may include a plurality of sets of emotion factor values that are received by call routing system 214 during a time since composite emotion model 220 was last trained by training unit 420.

Agent selection system 222 illustrated in FIG. 2 may receive the composite emotional score for a communication from composite emotion model 220 as one of a plurality of inputs to determine a routing recommendation for the current communication associated with the customer that identifies an agent having appropriate expertise to handle the current communication associated with the customer. Agent selection system 222 may determine the routing recommendation on a number of inputs, for example a duration that the matter related to the current communication has remained open, a number of communications related to the same open matter, a subject matter of the communication, and/or periodic composite emotional scores as discussed above. Agent selection system 222 may transmit the routing recommendation indicating a recommended agent to handle the current communication to one or more agent devices of a current agent handling the communication. Agent selection system 222 may route the current communication to the recommended agent automatically, or with approval from the current agent handling the communication. The recommended agent may be able to better handle the subject matter of the current communication, may be senior enough to have access to tools needed to resolve the matter associated with the current communication, and/or may be more effective in calming the customer associated with the current communication to aid in customer retention.

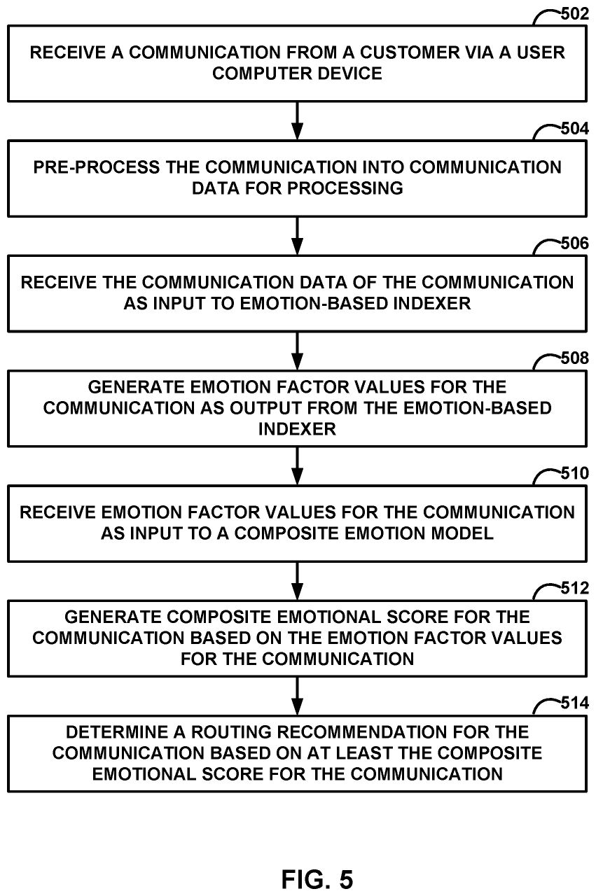

FIG. 5 is a flow diagram illustrating an example process for determining a routing recommendation for a customer communication, in accordance with the techniques of this disclosure. The example process of FIG. 5 may be performed by call routing system 214 of FIG. 2, including DIVA indexer 10, e.g., running on computing system 300 of FIG. 3, composite emotion model 220, e.g., running on computing system 400 of FIG. 4, and agent selection system 222.

Call routing system 214 may receive data representing a current communication from a customer, wherein the data can be used to determine a routing recommendation for the current communication associated with the customer that identifies an agent having appropriate expertise to handle the current communication associated with the customer (502). The customer may send the current communication from user device 206 to one or more servers or other computing devices of call routing system 214. The current communication may be in the form of a text, call, letter, email, or other form of communication.

Once call routing system 214 receives the current communication, data pre-processor 2 may pre-process the current communication into communication data for further processing (504). The communication data may be in plain text format, where data pre-processor 2 digitally transcribes audio messages into plain text format, or an employee of the organization manually transcribes the audio message into plain text format. In some examples, data pre-processor 2 transcribes visual data (from scanned documents, pdf files, image files etc.) into plain text format, or an employee of the organization manually transcribes visual data into plain text format. Data pre-processor 2 may include a speech recognition model, e.g., a natural language processing (NLP) engine, configured to convert audio customer service inquiries to plain text data via natural language processing. In other examples, data pre-processor 2 may include a text image recognition model configured to convert hand- or typewritten customer service inquiries to plain text data or text-based annotation data.

The current communication may be an ongoing communication between the customer and the organization, where the customer has been engaged in conversation with an agent of the organization for a period of time and is currently still engaged in the conversation. For example, the communication may include a duration. In some examples, the communication data includes communication data received over an entirety of the duration. For example, a current communication may start at a certain time, have lasted for five minutes so far, and be ongoing. The communication data over the entirety of the duration may include the communication data of the entire five minutes of the communication so far.

In some examples, the communication data may include communication data received over an interval of the duration. For example, a current communication may start at a certain time, have lasted for ten minutes so far, and be ongoing. The ten minute duration may be separated into a first five minute interval and a second five minute interval. The communication data received over an interval of the duration may include communication data from the second five minute interval. In some examples, the interval may be any time duration (e.g., two minutes, ten minutes). Receiving the set of emotion factor values may include applying, by the one or more processors, the communication data received over the entirety of the duration to the emotion-based indexer (e.g., composite emotion model 220) as input.

DIVA indexer 10 then receives and applies, by one or more processors, the processed communication data as input to the machine learning algorithms within DIVA indexer 10 (506). DIVA indexer 10 comprises multiple machine learning models, including a determination model 12, inquisitiveness model 14, valence model 16, and aggression model 18. The machine learning models within DIVA indexer 10 may accept plain text or text-based annotation data as input, where the communication data received is associated with a single communication submitted by the customer. In some examples, DIVA indexer 10 applies, by the one or more processors, the communication data received over the entirety of the duration to the emotion-based indexer as input. In some examples, DIVA indexer 10 applies, by the one or more processors, the communication data received over the interval of the duration to the emotion-based indexer as input.

DIVA indexer 10 generates a current set of emotion factor values, where each of the machine learning models within DIVA indexer 10 is configured to generate a single emotion factor value as output (508). Each of the emotion factor values may be indicative of an emotive intensity present in the communication data. For example, determination model 12 may generate a determination value comprising an integer between −2 and 2 (inclusive). A determination value of −2 may indicate that the customer communication conveys a low determination, where the customer may feel undecided on an issue. A determination value of 2 may indicate that the customer communication conveys a high determination value, where the customer may feel fixated on an issue. Similarly, inquisitiveness model 14 may generate an inquisitiveness value, valence model 16 may generate a valence value, and aggression model 18 may generate an aggression value, where each emotion factor value may be an integer between −2 and 2 (inclusive), representing the intensity of the respective emotion as conveyed in the customer communication. DIVA indexer 10 may store the four emotion factor values for the current communication in emotion factor index database 22 as associated with the communication data and the customer who sent the current communication.

In some examples, call routing system 214 may generate, by the one or more processors, the set of emotion factor values for the entirety of the duration of the current communication. For example, call routing system 214 may include a buffer to apply communication data received over the entirety of the duration to DIVA indexer 10 in one or more interims. The buffer may store the entirety of the communication data for the current communication as the communication data is received in real time, and intermittently apply the communication data received over the entirety of the duration to DIVA indexer 10. For example, call routing system 214 may continually receive communication data for the current communication for an interim of five minutes. After the five minute interim, call routing system 214 may apply the communication data of the entirety of the first five minutes to DIVA indexer 10. Call routing system 214 may continue to receive communication data for the current communication for another five minute interim for an entire duration of ten minutes. After ten minutes, call routing system 214 may apply the communication data of the entirety of the ten minutes to DIVA indexer 10. Call routing system 214 may continue to apply the communication data received over the entirety of the duration to DIVA indexer 10 every interim (e.g., five minutes) until the current communication ends. In some examples, call routing system 214 may apply the communication data received over the entirety of the duration to DIVA indexer 10 after the communication ends, even if the communication ends before the end of another interim. Call routing system 214 may store the communication data for the entirety of the current communication in memory as associated with the customer and/or other values stored in memory (e.g., a set of emotion factor values for the communication data, an identifier linked to an open matter, a subject matter classification, an identifier indicative of the current communication) before wiping the buffer for the next communication. In some examples, the interim may be any length of time (e.g., two minutes, ten minutes, etc.) In this way, call routing system 214 may continually update the communication data for the entirety of the duration of the current communication, and, by applying the communication data to DIVA indexer 10, call routing system 214 may subsequently continually generate an updated set of emotion factor values for the entirety of the duration of the current communication.

In some examples, call routing system 214 may generate, by the one or more processors, the set of emotion factor values for the interval of the current communication. For example, call routing system 214 may include a buffer to apply communication data received over the interval of the duration to DIVA indexer 10. The buffer may store the interval of the communication data for the current communication as the communication data is received in real time, and intermittently apply the communication data received over the interval to DIVA indexer 10. For example, the call routing system 214 may continually receive communication data for the current communication in five minute intervals. After a first interval, call routing system 214 may apply the communication data of the entirety of the first interval to DIVA indexer 10. Call routing system 214 may store the communication data received over each interval in memory as associated with the customer and/or other values stored in memory (e.g., a set of emotion factor values for the communication data, an identifier linked to an open matter, a subject matter classification, an identifier indicative of the current communication) before wiping the buffer for the next interval. The buffer of call routing system 214 may continue to receive communication data for a second interval (e.g., five minutes), such that the entire duration of the current communication is ten minutes. After the second interval, call routing system 214 may apply the communication data received over the second interval to DIVA indexer 10. Call routing system 214 may continue to apply the communication data received to DIVA indexer 10 in intervals (e.g., every five minutes) until the current communication ends. In some examples, the duration of the current communication after it ends may not be a perfect multiple of the interval, so call routing system 214 may apply the communication data received in a final period of time since the last full interval of the current communication to DIVA indexer 10 after the communication ends, even if the final period is shorter than the interval. In some examples, the interval may be any length of time (e.g., two minutes, ten minutes, etc.) In this way, call routing system 214 may continually update the communication data for the entirety of the duration of the current communication, and, by applying the communication data to DIVA indexer 10, call routing system 214 may subsequently continually generate the set of emotion factor values for each interval of the duration of the current communication.

Composite emotion model 220 then retrieves the set of emotion factor values for the current communication associated with the customer from the emotion factor index database 22, or may receive the set of emotion factor values from DIVA indexer 10 as input (510). In some examples, composite emotion model 220 also receives on one or more historic sets of emotion factor values stored in a database, wherein the one or more historic sets of emotion factor values correspond to communication data of one or more historic communications associated with the customer over time, the historic communications occurring prior to the current communication.

In some examples, retrieving the set of emotion factor values may include receiving the set of emotion factor values for the entirety of the duration of the current communication based on the communication data for the entirety of the duration of the current communication. In some examples, retrieving the set of emotion factor values may include receiving the set of emotion factor values for the interval of the duration of the current communication based on the communication data for the interval of the duration of the current communication.

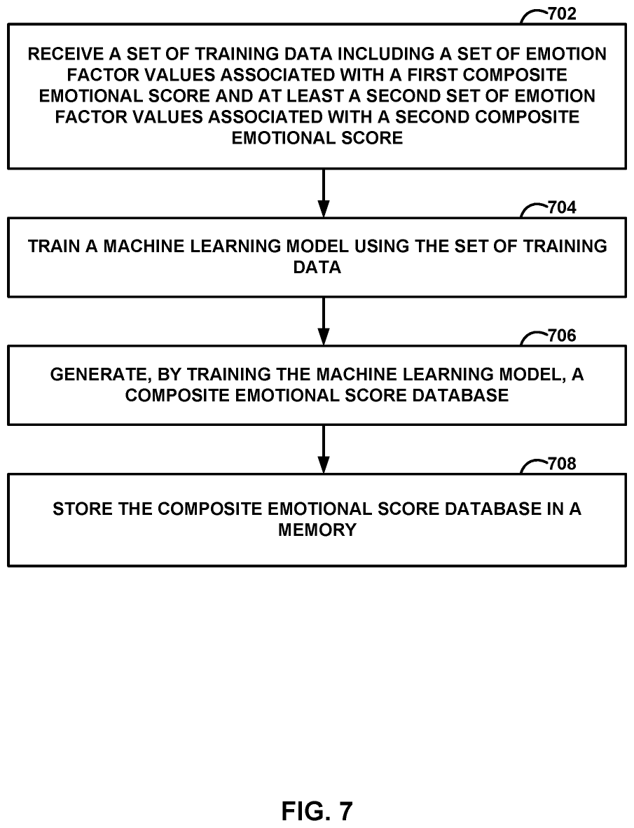

Composite emotion model 220 then generates a composite emotional score for the communication based on the set of emotion factor values for the communication (512). In some examples emotion composite emotion model 220 is a machine learning model, trained as described below with respect to FIG. 7 to determine a composite emotional score for the current communication. In some examples, the temporal risk score may be a number (e.g., zero or one, between zero and one hundred inclusive), where higher numbers may reflect a heightened emotional state of the customer associated with the current communication. Composite emotion model 220 may store the composite emotional score in a composite emotional score database 216 as associated with the current communication and the set of emotion factor values for the current communication.

In some examples, composite emotion model 220 may be a machine learning model. Call routing system 214 may apply the set of emotion factor values for the current communication associated with the customer to composite emotion model composite emotion model 220 as input. Composite emotion model 220 may determine, as output from composite emotion model 220, the composite emotional score for the current communication.

In order to train composite emotion model 220 as a machine learning model, the one or more processors of call routing system 214 may create a set of training data that includes a plurality of communications, wherein each communication of the plurality of communications comprises a corresponding set of emotion factor values and a label identifying an associated composite emotional score. The one or more processors may train composite emotion model 220 based on the set of training data.

In some examples, composite emotion model 220 may be a business rule-based model for generating a composite emotional score for the current communication. For example, composite emotion model 220 may compare each of the current set of emotion factor values to one or more thresholds for the emotion factor values and generate a composite emotional score based on one or more of the current emotion factor values exceeding or falling below a threshold. For example, composite emotion model 220 may extract one or more of an aggression value or valence value from the set of emotion factor values for the current communication and determine the composite emotional score based on the one or more of the aggression value or the valence value for the customer over time.

In some examples, in response to the aggression value exceeding a first threshold, composite emotion model 220 may generate a first composite emotional score indicative of a slight need to route the current communication to an agent having experience handling slightly aggressive customers. In response to the aggression value exceeding a second threshold, where the second threshold is higher than the first threshold, composite emotion model 220 may generate a second composite emotional score, where the second composite emotional score may be indicative of a need route the current communication to an agent having appropriate expertise to handle very aggressive customers.

In some examples, in response to the valence value falling below a first threshold, composite emotion model 220 may generate a first composite emotional score indicative of a slight need to route the current communication to an agent having experience handling slightly sad customers. In response to the valence value falling below a second threshold, where the second threshold is lower than the first threshold, composite emotion model 220 may generate a second composite emotional score, where the second composite emotional score may be indicative of a need route the current communication to an agent having appropriate expertise to handle very sad customers.

In some examples, in response to multiple of the current emotion factor values either exceeding or falling below a threshold, emotion factor index database emotion factor index database 22 may generate a composite emotional score indicative of the need to route the current communication to an agent having experience handling each trait of the customer. For example, composite emotion model 220 may access a table in memory that tabulates composite emotional scores representing multiple emotions, and composite emotion model 220 may identify a composite emotional score representing multiple emotions based on each of the current emotion factor values that exceeds or falls below a threshold.

In some examples, composite emotion model 220 may determine the composite emotional score for the current communication based on one or more historic sets of emotion factor values stored in a database, wherein the one or more historic sets of emotion factor values correspond to communication data of one or more historic communications associated with the customer over time, the historic communications occurring prior to the current communication. For example, call routing system 214 may apply the set of emotion factor values for the current communication and/or the one or more historic sets of emotion factor values associated with the customer to composite emotion model 220 as input and generate, as output, the composite emotional score for the current communication. For example, composite emotion model 220 may calculate an average set of emotion factor values for the customer from the one or more historic sets of emotion factor values associated with the customer. In response to the current set of emotion factor values differing a threshold amount from the average set of emotion factor values, composite emotion model 220 may determine a composite emotional score for the current communication.

In some examples, composite emotion model 220 may generate the composite emotional score for the entirety of the duration of the current communication based on the set of emotion factor values for the entirety of the duration of the current communication, as described above. For example, composite emotion model 220 may generate one or more composite emotional scores over one or more interims of the duration of the current communication. Composite emotion model 220 may store each composite emotional score of the one or more composite emotional scores in composite emotional score database 216 as associated with the current communication and/or other values stored in memory (e.g., the customer, the set of emotion factor values used to generate the composite emotional score, an identifier linked to an open matter, a subject matter classification). Composite emotional scores determined in this way that are not the current composite emotional score (e.g., the last composite emotional score determined for the current communication) may be referred to as interim composite emotional scores.

In some examples, composite emotion model 220 may generate the composite emotional score for an interval of the current communication based on the set of emotion factor values for the interval of the current communication, as described above. For example, composite emotion model 220 may generate one or more composite emotional scores over one or more intervals of the duration of the current communication. Composite emotion model 220 may store each composite emotional score of the one or more composite emotional scores in composite emotional score database 216 as associated with the current communication and/or other values stored in memory (e.g., the customer, the set of emotion factor values used to generate the composite emotional score, an identifier linked to an open matter, a subject matter classification). Composite emotional scores determined in this way that are not the current composite emotional score (e.g., the last composite emotional score determined for the current communication) may be referred to as interval composite emotional scores. Interval composite emotional scores and interim composite emotional scores may both be referred to as types of periodic composite emotional scores.

Call routing system 214 then determines a routing recommendation for the current communication based on at least the composite emotional score for the current communication (514). The routing recommendation for the current communication associated with the customer may identifies an agent having appropriate expertise to handle the current communication associated with the customer based on at least the composite emotional score for the current communication. For example, composite emotion model 220 may transmit the composite emotional score for the current communication to agent selection system 222. Agent selection system 222 may receive the composite emotional score from composite emotion model 220 or may retrieve the composite emotional score from composite emotional score database 216.

In some examples, agent selection system 222 may be a business rule-based model configured to determine a routing recommendation for the current communication based on at least the composite emotional score. For example, agent selection system 222 may receive a composite emotional score indicative of an aggressive customer. Agent selection system 222 may search a database (e.g., agent database 226) in memory for an agent of the organization who has experience dealing with aggressive customers. For example, agent selection system 222 may search for an agent where the agent's file in memory may include an identifier indicating that the agent has participated in conflict resolution courses. In some examples, agent selection system 222 determine how many aggressive customers an agent has handled based on information in the agent's file in memory. If agent selection system 222 determines the agent has successfully handled a threshold number of communications where the customer was aggressive, agent selection system 222 may determine that the agent has appropriate expertise to handle the current communication and determine a routing recommendation with the determined agent as a recommended agent. In some examples, agent selection system 222 determines if an agent is already engaged in a current communication with a customer before determining that agent to be the recommended agent.

In some examples, determining a routing recommendation may include receiving a subject matter classification for the current communication and determining the routing recommendation for the current communication based on at least the subject matter classification for the current communication. For example, agent selection system 222 may receive the composite emotional score for the current communication indicative of an aggressive customer and a subject matter classification indicating that the communication is in relation to a specific loan associated with the customer. Agent selection system 222 may determine a routing recommendation to a recommended agent having experience with aggressive customers and experience with the type of loan associated with the customer. In this way, agent selection system 222 may determine a routing recommendation to an agent with expertise in both the emotional state of the customer as well as the subject matter of the current communication.

In some examples, determining a routing recommendation may include receiving an identifier for the current communication indicative of an open matter in the current communication, wherein the open matter represents an unresolved issue or incomplete service for the customer. The one or more processors of call routing system 214 and/or agent selection system 222 may determine a duration for which the open matter has remained open and determine the routing recommendation for the current communication based on at least the duration for which the open matter has remained open. In some examples, the customer may transmit an open matter identifier from a customer device when initiating the current communication that is received by call routing system 214 and/or agent selection system 222. For example, the customer may input an open matter identifier on the keypad (e.g., or digital representation thereof) of the customer's phone when calling the organization, wherein the open matter identifier is received by call routing system 214 through wide area network 204. In some examples, a current agent communicating with the customer may input the open matter identifier to call routing system 214 during the current communication using one or more agent devices 224. Call routing system 214 may store the open matter identifier in a database in memory. Agent selection system 222 may retrieve the open matter identifier from a database in memory, or may receive the open matter identifier from call routing system 214. Agent selection system 222 may determine a duration for which the open matter has remained open based on time stamps for historic communications of the customer stored in memory associated with the open matter identifier. Agent selection system 222 may compare the earliest time stamp found to an internal time stamp for one or more devices on which the processors of agent selection system 222 are running to determine the duration. Agent selection system 222 may determine a routing recommendation to more senior agents within the organization for longer determined durations of the open matter. Similarly, agent selection system 222 may determine a number of communications in memory associated with the open matter identifier and determine a routing recommendation to more senior agents for a higher determined number of communications associated with the open matter identifier.

In some examples, agent selection system 222 may receive one or more periodic composite emotional scores (as described above) from composite emotional score database 216. The one or more periodic composite emotional scores may be interval composite emotional scores and or interim composite emotional scores that were determined for the current communication prior to the current composite emotional score (e.g., the last composite emotional score determined for the current communication). For example, agent selection system 222 may determine the routing recommendation for the current communication based on the current composite emotional score for the entirety of the duration of the current communication. In some examples, agent selection system 222 may determine the routing recommendation for the current communication based on the current composite emotional score for the interval of the current communication, and also based on the one or more periodic composite emotional scores. For example, agent selection system 222 may determine the routing recommendation for the current communication based on a comparison between the current composite emotional score and the one or more periodic composite emotional scores for the current communication.

Agent selection system 222 may determine a routing recommendation based on a difference between the current composite emotional score for the current communication and the one or more periodic composite emotional scores for the current communication. For example, agent selection system 222 may determine an average composite emotional score for the current communication by calculating an average of the one or more periodic composite emotional scores for the current communication. If the current composite emotional score differs from the average composite emotional score by more than a threshold amount, agent selection system 222 may send an alert and a determined routing recommendation to a current agent suggesting routing the recommendation to a recommended agent. For example, during an ongoing communication, composite emotion model 220 may periodically determine one or more composite emotional scores for the current communication based on periodic communication data for the current communication. The periodic communication data may be based on intervals of the duration of the communication or interim determinations based on the entirety of the communication data received up to the current point in the ongoing communication. Agent selection system 222 may periodically determine one or more routing recommendations for the current communication based on the current composite emotional score for the current communication and one or more of the periodic composite emotional scores for the current communication, where the periodic composite emotional scores were determined prior to the current composite emotional score.

In some examples, call routing system 214 may receive an incoming communication from a customer, where communication data for the incoming communication is not available, and determine an initial routing recommendation. For example, call routing system 214 may receive a call from a customer, and determine an initial routing recommendation based on a detected phone number of the customer. For example, call routing system 214 may detect the phone number being used to contact the organization and look up the phone number in a database in memory to determine a potential customer. Based on the determined customer, call routing system 214 may retrieve the most recent communication data for the most recent communication with the customer from memory and determine an initial routing recommendation as described above based on the most recent communication data. Call routing system 214 may route the incoming communication to an agent identified in the initial routing recommendation.

The one or more processors of call routing system 214 may route the current communication in accordance with the routing recommendation to a computing device (e.g., agent devices 224) of the agent. For example, agent selection system 222 may determine a current agent who may be currently engaged with the customer in the current communication. Composite emotion model 220 may send the routing recommendation to agent device 224 of the current agent, recommending routing the communication to the recommended agent. The current agent may approve the routing recommendation and call routing system 214 may route the communication to the recommended agent. In some examples, the current agent may be a digital or artificial agent of call routing system 214 configured to receive information and communication data from the customer before routing the customer to a live agent. For example, call routing system call routing system 214 may include an online chatbot configured to prompt the customer for personally identifiable information, or information related to the matter associated with the communication. Call routing system 214 may automatically route the customer to a live agent after a sufficient amount of information has been received, or after prompted to be routed to a live agent by the customer. In some examples, the current agent is a live agent using agent device 224.

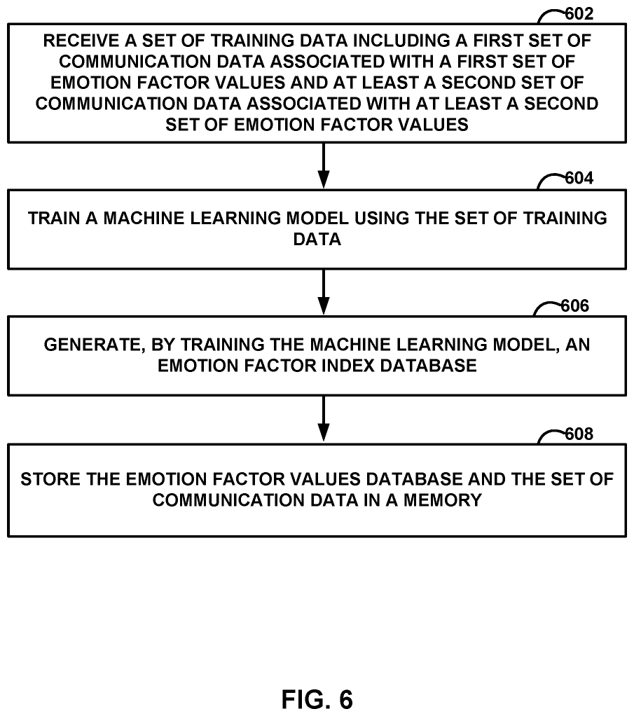

FIG. 6 is a flow diagram illustrating an example process for training an emotion-based indexer machine learning model, in accordance with the techniques of this disclosure. The example operation of FIG. 6 is described with respect to computing system 300 of FIG. 3 including DIVA indexer 10 and training unit 320. The emotion-based indexer may comprise determination model 12, inquisitiveness model 14, valence model 16, and aggression model 18 within DIVA indexer 10. Each model within DIVA indexer 10 may need to be trained individually with communication data labeled with their respective emotion factor values.

Training unit 320 may receive a set of training data 312 including data indicative of a first set of communication data associated with a first set of emotion factor values and at least a second set of communication data associated with a second set of emotion factor values (602). The sets of emotion factor values may each be comprised of a determination value, an inquisitiveness value, a valence value, and an aggression value, where each emotion factor value is comprised of an integer between negative two and two inclusive. In some examples, the first set of emotion factor values has different integer values than the second set of emotion factor values. In some examples, the set of communication data associated with the first set of emotion factor values may be approximately equal in size to the set of communication data associated with the second set of emotion factor values.

Training unit 320 may train the machine learning models within DIVA indexer 10 using training data 312 (604). Determination model 12 may be trained to determine a determination value based on input communication data representing a message. A machine learning model may be trained using a training process to create a data-specific model, such as determination model 12, based on training data 312. After the training process, determination model 12 may be capable of outputting a determination value representing a level of determination emotion in a message based on an input of communication data. The training process may implement a set of training data (e.g., training data 312) to create determination model 12.

Training data 312 may include a plurality of sets of communication data and emotion factor values as described above, wherein the determination values from the sets of emotion factor values are used to train determination model 12. The plurality of sets of communication data may include a group of communication data labeled with a determination value of negative 2, a group of communication data labeled with a determination value of negative one, a group of communication data labeled with a determination value of zero, a group of communication data labeled with a determination value of one, and a group of communication data labeled with a determination value of two, where each group of communication data of the plurality of sets of communication data is known to be labeled with a determination value of negative two, negative one, zero, one, or two. In one example, training data 312 contains data representing about equal numbers of sets of communication data labeled with determination values of each number negative two through two. In another example, training data 312 contains data including a greater number of sets of communication data labeled with a determination value of two than sets of communication data labeled with a determination value of zero. Other examples are contemplated wherein training data 312 contains data including an equal to or greater number of sets of communication data labeled with any particular determination value than a number of sets of communication data labeled with any other particular determination value. Training unit 320 may access training data 312 stored in storage units 310, and training unit 320 may train determination model 12 using training data 312.

Inquisitiveness model 14 may be trained to determine an inquisitiveness value based on input communication data representing a message. A machine learning model may be trained using a training process to create a data-specific model, such as inquisitiveness model 14, based on training data 312. After the training process, inquisitiveness model 14 may be capable of outputting an inquisitiveness value representing a level of inquisitiveness emotion in a message based on an input of communication data. The training process may implement a set of training data (e.g., training data 312) to create inquisitiveness model 14.

Training data 312 may include a plurality of sets of communication data and emotion factor values as described above, wherein the inquisitiveness values from the sets of emotion factor values are used to train inquisitiveness model 14. The plurality of sets of communication data may include a group of communication data labeled with an inquisitiveness value of negative 2, a group of communication data labeled with an inquisitiveness value of negative one, a group of communication data labeled with an inquisitiveness value of zero, a group of communication data labeled with an inquisitiveness value of one, and a group of communication data labeled with an inquisitiveness value of two, where each group of communication data of the plurality of sets of communication data is known to be labeled with an inquisitiveness value of negative two, negative one, zero, one, or two. In one example, training data 312 contains data representing about equal numbers of sets of communication data labeled with inquisitiveness values of each number negative two through two. In another example, training data 312 contains data including a greater number of sets of communication data labeled with an inquisitiveness value of two than sets of communication data labeled with an inquisitiveness value of zero. Other examples are contemplated wherein training data 312 contains data including an equal to or greater number of sets of communication data labeled with any particular inquisitiveness value than a number of sets of communication data labeled with any other particular inquisitiveness value. Training unit 320 may access training data 312 stored in storage units 310, and training unit 320 may train inquisitiveness model 14 using training data 312.

Valence model 16 may be trained to determine a valence value based on input communication data representing a message. A machine learning model may be trained using a training process to create a data-specific model, such as valence model 16, based on training data 312. After the training process, valence model 16 may be capable of outputting a valence value representing a level of valence emotion in a message based on an input of communication data. The training process may implement a set of training data (e.g., training data 312) to create valence model 16.

Training data 312 may include a plurality of sets of communication data and emotion factor values as described above, wherein the valence values from the sets of emotion factor values are used to train valence model 16. The plurality of sets of communication data may include a group of communication data labeled with a valence value of negative 2, a group of communication data labeled with a valence value of negative one, a group of communication data labeled with a valence value of zero, a group of communication data labeled with a valence value of one, and a group of communication data labeled with a valence value of two, where each group of communication data of the plurality of sets of communication data is known to be labeled with a valence value of negative two, negative one, zero, one, or two. In one example, training data 312 contains data representing about equal numbers of sets of communication data labeled with valence values of each number negative two through two. In another example, training data 312 contains data including a greater number of sets of communication data labeled with a valence value of two than sets of communication data labeled with a valence value of zero. Other examples are contemplated wherein training data 312 contains data including an equal to or greater number of sets of communication data labeled with any particular valence value than a number of sets of communication data labeled with any other particular valence value. Training unit 320 may access training data 312 stored in storage units 310, and training unit 320 may train valence model 16 using training data 312.

Aggression model 18 may be trained to determine an aggression value based on input communication data representing a message. A machine learning model may be trained using a training process to create a data-specific model, such as aggression model 18, based on training data 312. After the training process, aggression model 18 may be capable of outputting an aggression value representing a level of aggression emotion in a message based on an input of communication data. The training process may implement a set of training data (e.g., training data 312) to create aggression model 18.

Training data 312 may include a plurality of sets of communication data and emotion factor values as described above, wherein the aggression values from the sets of emotion factor values are used to train aggression model 18. The plurality of sets of communication data may include a group of communication data labeled with an aggression value of negative 2, a group of communication data labeled with an aggression value of negative one, a group of communication data labeled with an aggression value of zero, a group of communication data labeled with an aggression value of one, and a group of communication data labeled with an aggression value of two, where each group of communication data of the plurality of sets of communication data is known to be labeled with an aggression value of negative two, negative one, zero, one, or two. In one example, training data 312 contains data representing about equal numbers of sets of communication data labeled with aggression values of each number negative two through two. In another example, training data 312 contains data including a greater number of sets of communication data labeled with an aggression value of two than sets of communication data labeled with an aggression value of zero. Other examples are contemplated wherein training data 312 contains data including an equal to or greater number of sets of communication data labeled with any particular aggression value than a number of sets of communication data labeled with any other particular aggression value. Training unit 320 may access training data 312 stored in storage units 310, and training unit 320 may train aggression model 18 using training data 312.

By training the machine learning models within DIVA indexer 10, training unit 320 may generate an emotion factor index database 22 (606). The emotion factor index database 22 may include a plurality of emotion factor value sets, where each emotion factor value set of the plurality of emotion factor value sets corresponds to a respective message or communication data. Communication data may include words of the English language or other languages, single numerals, groups of single numerals, numerical strings, groups of numerical strings, single characters, groups of single characters, character strings, or groups of character strings in plain text format. As such, using emotion factor index database 22, the machine learning models within DIVA indexer 10 may determine a set of emotion factor values for a message or communication data. Training unit 320 may store emotion factor index database 22 in storage units 310 (608).

FIG. 7 is a flow diagram illustrating an example process for training a composite emotion model 220, in accordance with the techniques of this disclosure. The example operation of FIG. 7 is described with respect to computing system 400 of FIG. 4 including machine learning model, composite emotion model 220, and training unit 420.

Training unit 420 may receive a set of training data 412 including a group of sets of emotion factor values associated with customer communications and labeled with a first composite emotional score, and a group of sets of emotion factor values associated with customer communications and labeled with a second composite emotional score (702). In some examples, the group labeled with the first composite emotional score may be approximately equal in size to the group labeled with the second composite emotional score.

Training unit 420 may train composite emotion model 220 using training data 412 (704). Composite emotion model 220 may be trained to determine a composite emotional score for a communication based on an input set of emotion factor values associated with the communication. A machine learning algorithm may be trained using a training process to create a data-specific model, such as composite emotion model 220 based on training data 412. After the training process, composite emotion model 220 may be capable of determining a composite emotional score for a communication based on a set of emotion factor values. The training process may implement a set of training data (e.g., training data 412) to create the composite emotion model 220.

In a first example, training data 412 may include data indicative of a plurality of sets of emotion factor values labeled with a plurality of composite emotional scores, wherein the plurality of sets of emotion factor values labeled with a plurality of composite emotional scores comprises a first set of emotion factor values labeled with a first composite emotional score and at least a second set of emotion factor values labeled with a second composite emotional score. The plurality of sets of emotion factor values may include a particular number of groups (e.g., ten groups) of sets of emotion factor values where each of the groups includes data that is labeled with a particular composite emotional score. In one example, training data 412 contains data representing about equal numbers of sets of emotion factor values labeled with each composite emotional score. Other examples are contemplated wherein training data 412 contains data including a greater number of sets of emotion factor values labeled with any particular composite emotional score than a number of sets of emotion factor values labeled with any other particular composite emotional score. Training unit 420 may access training data 412 stored in storage units 410, and training unit 420 may train the composite emotion model 220 using training data 412.

By training composite emotion model 220, training unit 420 may generate a composite emotional score database 216 (706). Composite emotional score database 216 may include a plurality of composite emotional scores, where each composite emotional score of the plurality of composite emotional scores corresponds to one or more sets of emotion factor values associated with customer communications. Each composite emotional score of the plurality of composite emotional scores may be indicative of one or more emotion states of a customer associated with the customer communication reflecting a need to route the current communication to an agent having experience handling customers exhibiting the one or more emotion states. Using composite emotional score database 216, composite emotion model 220 may determine a composite emotional score for a communication given a set of emotion factor values for the communication. Training unit 420 may store composite emotional score database 216 in storage units 410 (708).

In one or more examples, the functions described may be implemented in hardware, software, firmware, or any combination thereof. If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A computing system comprising:
a memory; and
one or more processors in communication with the memory and configured to:
receive a set of emotion factor values for communication data of a current communication associated with a customer, wherein each emotion factor value of the set of emotion factor values indicates a measure of a different emotion in the current communication, and wherein the set of emotion factor values comprises a determination value for the current communication, an inquisitiveness value for the current communication, a valence value for the current communication, and an aggression value for the current communication;
generate, using a composite emotion model running on the one or more processors, a first composite emotional score for the current communication based on the set of emotion factor values for the current communication associated with the customer, wherein the composite emotion model comprises a machine learning model trained on a set of training data;
determine a first routing recommendation for the current communication associated with the customer that identifies an agent having appropriate expertise to handle the current communication associated with the customer based on at least the first composite emotional score for the current communication;
route the current communication in accordance with the first routing recommendation to a computing device of the agent;
re-train the composite emotion model based on an updated set of training data, wherein the updated set of training data includes an updated plurality of customer communications, wherein each customer communication in the updated plurality of customer communications comprises a corresponding set of emotion factor values and a label identifying a corresponding composite emotional score for a customer associated with the customer communication, and wherein the updated plurality of customer communications includes the current communication comprising the set of emotion factor values and the first composite emotional score;
generate, using the re-trained composite emotion model, a second composite emotional score for a subsequent communication based on a set of emotion factor values for a subsequent communication associated with the customer; and
determine a second routing recommendation for the subsequent communication associated with the customer that identifies an agent having appropriate expertise to handle the subsequent communication based on at least the second composite emotional score for the subsequent communication.

2. The computing system of claim 1, wherein the one or more processors are further configured to:
receive the communication data of the current communication;
apply the communication data to an emotion-based indexer as input, wherein the emotion-based indexer includes a set of machine learning models, each machine learning model trained to determine the measure of the different emotion in the current communication;
generate, as output from the emotion-based indexer, the set of emotion factor values for the current communication; and
store the set of emotion factor values for the current communication in a database.

3. The computing system of claim 2, wherein the current communication comprises a duration, and the communication data comprises communication data received over an entirety of the duration;
wherein the processors are configured to:
apply the communication data received over the entirety of the duration to the emotion-based indexer as input; and
generate the set of emotion factor values for the entirety of the duration of the current communication;
wherein, to generate the first composite emotional score for the current communication, the processors are configured to generate the first composite emotional score for the entirety of the duration of the current communication based on the set of emotion factor values for the entirety of the duration of the current communication; and
wherein, to determine the first routing recommendation, the processors are configured to determine the first routing recommendation for the current communication based on the first composite emotional score for the entirety of the duration of the current communication.

4. The computing system of claim 2, wherein the current communication comprises a duration, and the communication data comprises communication data received over an interval of the duration;
wherein the processors are configured to:
apply the communication data received over the interval to the emotion-based indexer as input; and
generate the set of emotion factor values for the interval of the current communication;
wherein, to generate the first composite emotional score for the current communication, the processors are configured to generate the first composite emotional score for the interval of the current communication based on the set of emotion factor values for the interval of the current communication; and
wherein, to determine the first routing recommendation, the processors are configured to determine the first routing recommendation for the current communication based on the first composite emotional score for the interval of the current communication.

5. The computing system of claim 1, wherein the first composite emotional score for the current communication comprises a current composite emotional score, and wherein the one or more processors are configured to:
determine one or more periodic composite emotional scores for the current communication based on one or more intervals or interims of a duration of the current communication; and
determine the first routing recommendation for the current communication based on a comparison between the current composite emotional score and the one or more periodic composite emotional scores for the current communication.

6. The computing system of claim 1, wherein the one or more processors are configured to:
receive a subject matter classification for the current communication; and
determine the first routing recommendation for the current communication based on at least the subject matter classification for the current communication.

7. The computing system of claim 1, wherein to determine the first composite emotional score for the current communication, the one or more processors are configured to:
extract one or more of an aggression value or valence value from the set of emotion factor values for the current communication; and
determine the first composite emotional score based on the one or more of the aggression value or the valence value for the customer over time.

8. The computing system of claim 1, wherein to determine the first composite emotional score for the current communication, the one or more processors are configured to:
apply the set of emotion factor values for the current communication to the composite emotion model as input; and
determine, as output from the composite emotion model, the first composite emotional score for the current communication.

9. The computing system of claim 8, wherein the one or more processors are configured to:
create a set of training data that includes a plurality of communications, wherein each communication of the plurality of communications comprises a corresponding set of emotion factor values and a label identifying an associated composite emotional score; and
train the machine learning model based on the set of training data.

10. (canceled)

11. The computing system of claim 1, wherein the one or more processors are configured to:
receive an identifier for the current communication indicative of an open matter in the current communication, wherein the open matter represents an unresolved issue or incomplete service for the customer;
determine a duration for which the open matter has remained open; and
determine the first routing recommendation for the current communication based on at least the duration for which the open matter has remained open.

12. A method comprising:
receiving, by one or more processors, a set of emotion factor values for communication data of a current communication associated with a customer, wherein each emotion factor value of the set of emotion factor values indicates a measure of a different emotion in the current communication, and wherein the set of emotion factor values comprises a determination value for the current communication, an inquisitiveness value for the current communication, a valence value for the current communication, and an aggression value for the current communication;
generating, using a composite emotion model running on the one or more processors, a first composite emotional score for the current communication based on the set of emotion factor values for the current communication associated with the customer, wherein the composite emotion model comprises a machine learning model trained on a set of training data;
determining, by the one or more processors, a first routing recommendation for the current communication associated with the customer that identifies an agent having appropriate expertise to handle the current communication associated with the customer based on at least the first composite emotional score for the current communication;
routing, by the one or more processors, the current communication in accordance with the first routing recommendation to a computing device of the agent;
re-training the composite emotion model based on an updated set of training data, wherein the updated set of training data includes an updated plurality of customer communications, wherein each customer communication in the updated plurality of customer communications comprises a corresponding set of emotion factor values and a label identifying a corresponding composite emotional score for a customer associated with the customer communication, and wherein the updated plurality of customer communications includes the current communication comprising the set of emotion factor values and the first composite emotional score;
generating, using the re-trained composite emotion model, a second composite emotional score for a subsequent communication based on a set of emotion factor values for a subsequent communication associated with the customer; and
determining a second routing recommendation for the subsequent communication associated with the customer that identifies an agent having appropriate expertise to handle the subsequent communication based on at least the second composite emotional score for the subsequent communication.

13. The method of claim 12, further comprising:
receiving, by the one or more processors, the communication data of the current communication;
applying, by the one or more processors, the communication data to an emotion-based indexer as input, wherein the emotion-based indexer includes a set of machine learning models, each machine learning model trained to determine the measure of the different emotion in the current communication;
generating, by the one or more processors as output from the emotion-based indexer, the set of emotion factor values for the current communication; and
storing, by the one or more processors, the set of emotion factor values for the current communication in a database.

14. The method of claim 13, wherein the current communication comprises a duration, and the communication data comprises communication data received over an entirety of the duration;
wherein the method comprises:
applying, by the one or more processors, the communication data received over the entirety of the duration to the emotion-based indexer as input; and
generating, by the one or more processors, the set of emotion factor values for the entirety of the duration of the current communication;
wherein generating the first composite emotional score for the current communication comprises generating, by the one or more processors, the first composite emotional score for the entirety of the duration of the current communication based on the set of emotion factor values for the entirety of the duration of the current communication; and
wherein determining the first routing recommendation for the current communication comprises determining, by the one or more processors, the first routing recommendation for the current communication based on the first composite emotional score for the entirety of the duration of the current communication.

15. The method of claim 13, wherein the current communication comprises a duration, the communication data comprises communication data received over an interval of the duration,
wherein the method comprises:
applying, by the one or more processors, the communication data received over the interval to the emotion-based indexer as input; and
generating, by the one or more processors, the set of emotion factor values for the interval of the current communication;
wherein generating the first composite emotional score for the current communication comprises generating, by the one or more processors, the first composite emotional score for the interval of the current communication based on the set of emotion factor values for the interval of the current communication; and
wherein determining the first routing recommendation for the current communication comprises determining, by the one or more processors, the first routing recommendation for the current communication based on the first composite emotional score for the interval of the current communication.

16. The method of claim 12, further comprising determining the first composite emotional score for the current communication based on one or more historic sets of emotion factor values stored in a database, wherein the one or more historic sets of emotion factor values correspond to communication data of one or more historic communications associated with the customer over time, the historic communications occurring prior to the current communication.

17. The method of claim 12, further comprising:
receiving, by the one or more processors, a subject matter classification for the current communication; and
determining, by the one or more processors, the first routing recommendation for the current communication based on at least the subject matter classification for the current communication.

18. The method of claim 12, further comprising:
extracting, by the one or more processors, one or more of an aggression value or valence value from the set of emotion factor values for the current communication; and
determining, by the one or more processors, the first composite emotional score based on the one or more of the aggression value or the valence value for the customer over time.

19. The method of claim 12, and wherein determining the first composite emotional score for the current communication further comprises:
creating, by the one or more processors, a set of training data that includes a plurality of communications, wherein each communication of the plurality of communications comprises a corresponding set of emotion factor values and a label identifying an associated composite emotional score;
training, by the one or more processors, the machine learning model based on the set of training data;
applying, by the one or more processors, the set of emotion factor values for the current communication to the composite emotion model as input; and
determining, by the one or more processors as output from the composite emotion model, the first composite emotional score for the current communication.

20. The method of claim 12, further comprising:
receiving, by the one or more processors, an identifier for the current communication indicative of an open matter in the current communication, wherein the open matter represents an unresolved issue or incomplete service for the customer;
determining, by the one or more processors, a duration for which the open matter has remained open; and
determining, by the one or more processors, the first routing recommendation for the current communication based on at least the duration for which the open matter has remained open.

21. A computer-readable medium comprising instructions that, when executed, cause one or more processors to:
receive a set of emotion factor values for communication data of a current communication associated with a customer, wherein each emotion factor value of the set of emotion factor values indicates a measure of a different emotion in the current communication, and wherein the set of emotion factor values comprises a determination value for the current communication, an inquisitiveness value for the current communication, a valence value for the current communication, and an aggression value for the current communication;
generate, using a composite emotion model running on the one or more processors, a first composite emotional score for the current communication based on the set of emotion factor values for the current communication associated with the customer, wherein the composite emotion model comprises a machine learning model trained on a set of training data;
determine a first routing recommendation for the current communication associated with the customer that identifies an agent having appropriate expertise to handle the current communication associated with the customer based on at least the first composite emotional score for the current communication;
route the current communication in accordance with the first routing recommendation to a computing device of the agent;
re-train the composite emotion model based on an updated set of training data, wherein the updated set of training data includes an updated plurality of customer communications, wherein each customer communication in the updated plurality of customer communications comprises a corresponding set of emotion factor values and a label identifying a corresponding composite emotional score for a customer associated with the customer communication, and wherein the updated plurality of customer communications includes the current communication comprising the set of emotion factor values and the first composite emotional score;
generate, using the re-trained composite emotion model, a second composite emotional score for a subsequent communication based on a set of emotion factor values for a subsequent communication associated with the customer; and
determine a second routing recommendation for the subsequent communication associated with the customer that identifies an agent having appropriate expertise to handle the subsequent communication based on at least the second composite emotional score for the subsequent communication.
